(19) United States
(12) Patent Application Publication
(10) Pub. No.: US 2008/0076062 A1
(43) Pub. Date: Mar. 27, 2008

(54) RESIST COMPOSITION AND PATTERN-FORMING METHOD USING THE SAME

(75) Inventor: Masaomi MAKINO, Haibara-gun (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 11/859,269

(22) Filed: Sep. 21, 2007

(30) Foreign Application Priority Data
Sep. 21, 2006 (JP) 2006-256266

(51) Int. Cl. G03C 1/73; G03C 5/00

(52) U.S. Cl. 430/270.1; 430/327; 528/425

(57) ABSTRACT

A resist composition includes (A) a resin that includes a repeating unit represented by the following formula (1), and an acid-decomposable crosslinking group; and (B) a compound that generates an acid upon irradiation with an actinic ray or radiation: 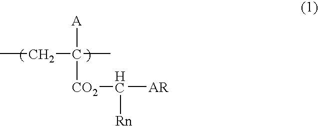 wherein AR represents a benzene ring or a naphthalene ring; Rn represents an alkyl group, a cycloalkyl group, or an aryl group; and A represents a hydrogen atom, an alkyl group, a cycloalkyl group, a halogen atom, a cyano group, or an alkyloxycarbonyl group.

### BACKGROUND OF THE INVENTION

1. Field of the Invention

The present invention relates to a resist composition preferably used in super-microlithography processes such as the manufacture of super LSI and high capacity microchips, and other photo-publication processes. More specifically, the invention relates to a positive resist capable of forming a highly refined pattern with KrF excimer laser beams, electron beams, or EUV rays, and a positive resist composition suitable for fine processing of semiconductor devices with KrF excimer laser beams, electron beams, or EUV rays, and a pattern forming method using the same.

2. Description of the Related Art

In the manufacturing process of semiconductor devices such as IC and LSI, fine processing by lithography using photoresist compositions has been conventionally carried out. In recent years, with the increment of integration of integrated circuits, hyperfine pattern formation of the levels of a sub-micron and quarter-micron has come to be required. Under such a circumstance, the exposure wavelengths show a tendency to be shortening, such as from g-line to i-line, further to KrF excimer laser beam. Further, lithography using electron beams, X-rays or EUV rays in addition to excimer laser beams has been developed nowadays.

Lithography using electron beams and EUV rays is taken as the pattern forming technique of the next generation or the next to the next generation, so that resists of high sensitivity and high resolution are required. The increase in sensitivity is a very important object in view of shortening of the processing time of wafers, but in positive resists for electron beams and EUV rays, pursuit of increment of sensitivity is accompanied by not only reduction of resolution but also deterioration of Iso Dense Bias, so that the development of a resist satisfying these characteristics at the same time is strongly desired. Iso Dense Bias here means the difference in pattern dimension between a part where the density of a resist pattern is high and a part where the density is low. When the difference is great, process margin becomes unfavorably narrow at the time of actual pattern formation, so that how to make the difference small is one of the important objects in the development of resist technique. High sensitivity, high resolution, a good pattern form and good Iso Dense Bias are in relationship of trade-off, and how to satisfy these factors at the same time is a very important object.

In lithography using KrF excimer laser beams, it is also an important object to reconcile high sensitivity, high resolution, a good pattern form and good Iso Dense Bias at the same time, and the resolution of this problem is indispensable.

As the resist suitable for lithographic process using KrF excimer laser beams, electron beams, or EUV rays, chemical amplification resists utilizing acid catalytic reaction are mainly used from the viewpoint of the enhancement of sensitivity, and in positive resists, chemical amplification resist compositions mainly comprising phenolic polymers having properties that are insoluble or hardly soluble in an alkali developing solution but become soluble in an alkali developing solution by the action of an acid (hereinafter referred to as a phenolic acid-decomposable resin), and acid generators are effectively used.

In connection with these positive resists, some resist compositions using phenolic acid-decomposable resins obtained by copolymerization of acid-decomposable acrylate monomers having an alicyclic group as the acid-decomposable group are known. Regarding these compositions, the positive resist compositions disclosed, e.g., in U.S. Pat. No. 5,561,194, JP-A-2001-166474 (The term “JP-A” as used herein refers to an “unexamined published Japanese patent application”.), JP-A-2001-166478 and JP-A-2003-107708 can be exemplified.

A resist containing a resin having an acid-decomposable tertiary ester repeating unit and an acid-decomposable ester crosslinking repeating unit is disclosed in U.S. Pat. No. 6,630,282, and a resist containing a resin having an acid-decomposable tertiary ester repeating unit and an acid-decomposable acetal crosslinking repeating unit is disclosed in JP-A-2002-20639.

However, it is the present situation that high sensitivity, LWR (line width roughness) and reduction of Iso Dense Bias in a hyperfine region cannot be satisfied at the same time with any of these combinations.

### SUMMARY OF THE INVENTION

An object of the invention is to solve the problems of the improving technique of performances in fine processing of semiconductor devices using an actinic ray or radiation, in particular, KrF excimer laser beams, electron beams or EUV rays. Another object is to provide a resist composition capable of satisfying high sensitivity, LWR, and reduction of Iso Dense Bias at the same time, and showing good dissolution contrast, and a further object is to provide a pattern-forming method using the same.

As a result of eager examinations, the present inventors have found that the above objects of the invention can be achieved surprisingly by the use of a resist composition containing the resin obtained by intramolecularly or intermolecularly crosslinking a polymer containing a secondary benzyl acid-decomposable group with an acid-decomposable crosslinking group, and a compound capable of generating an acid upon irradiation with an actinic ray or radiation (an acid generator).

That is, the invention can be achieved by the following constitutions.

<1> A resist composition comprising:

(A) a resin that comprises:
a repeating unit represented by the following formula (1), and
an acid-decomposable crosslinking group; and

(B) a compound that generates an acid upon irradiation with an actinic ray or radiation:

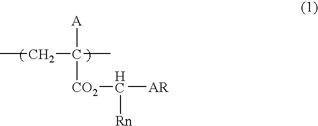

wherein AR represents a benzene ring or a naphthalene ring;

Rn represents an alkyl group, a cycloalkyl group, or an aryl group; and

A represents a hydrogen atom, an alkyl group, a cycloalkyl group, a halogen atom, a cyano group, or an alkyloxycarbonyl group.

<2> The resist composition as described in <1>,

wherein the acid-decomposable crosslinking group is a group represented by the following formula (2) or (3):

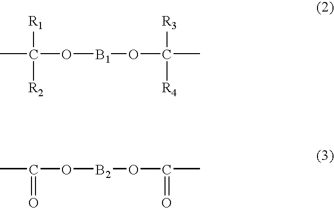

wherein R₁, R₂, R₃ and R₄ may be the same or different, each of them represents a hydrogen atom, an alkyl group, or a cycloalkyl group, R₁ and R₂ do not represent a hydrogen atom at the same time, R₃ and R₄, do not represent a hydrogen atom at the same time, R₁ and R₂ may form a ring, and R₃ and R₄, may form a ring;

B₁ represents a divalent organic group, and at least one of whose bonds with the adjacent oxygen atoms is broken by action of an acid; and

B₂ represents a divalent organic group and at least one of whose bonds with the adjacent oxygen atoms is broken by action of an acid.

<3>. The resist composition as described in <1>,

wherein the resin (A) further comprises a repeating unit represented by the following formula (4):

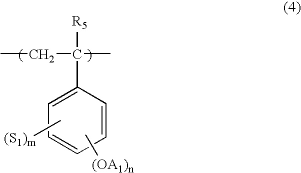

wherein n and m each represents an integer of from 0 to 3, provided that m+n≦5;

A₁ represents a hydrogen atom, or a group comprising a group that decomposes by action of an acid, and when two or more A₁s are present, they may be the same or different;

S₁ represents a substituent, and when two or more S₁s are present, they may be the same or different; and

R₅ represents a hydrogen atom, an alkyl group, a cycloalkyl group, a halogen atom, a cyano group, or an alkyloxycarbonyl group.

<4> The resist composition as described in <3>,

wherein the group represented by A₁ comprises a cyclic carbon structure.

<5> A pattern forming method comprising:

a processes of forming a resist film with the resist composition as described in <1>;

a process of exposing the resist film; and

a process of developing the resist film.

<6> A resin comprising:

a repeating unit represented by the following formula (1); and

an acid-decomposable crosslinking group:

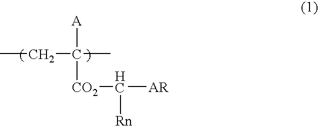

wherein AR represents a benzene ring or a naphthalene ring;

Rn represents an alkyl group, a cycloalkyl group, or an aryl group; and

A represents a hydrogen atom, an alkyl group, a cycloalkyl group, a halogen atom, a cyano group, or an alkyloxycarbonyl group.

### DETAILED DESCRIPTION OF THE INVENTION

The compounds for use in the invention will be described in detail below.

In the description of a group (an atomic group) in the specification of the invention, the description not referring to substitution or unsubstitution includes both a group not having a substituent and a group having a substituent. For example, “an alkyl group” includes not only an alkyl group having no substituent (an unsubstituted alkyl group) but also an alkyl group having a substituent (a substituted alkyl group).

The resist composition in the invention comprises resin (A) containing a repeating unit represented by formula (1) and an acid-decomposable crosslinking group, and acid generator compound (B).

[1] Resin Containing a Repeating Unit Represented by Formula (1) and an Acid-Decomposable Crosslinking Group:

The resist composition in the invention comprises resin (A) containing a repeating unit represented by formula (1).

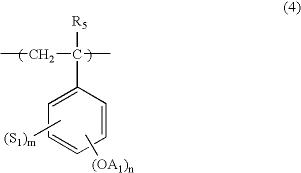

In formula (1), AR represents a benzene ring or a naphthalene ring; Rn represents an alkyl group, a cycloalkyl group, or an aryl group; and A represents a hydrogen atom, an alkyl group, a cycloalkyl group, a halogen atom, a cyano group, or an alkyloxycarbonyl group.

The benzene ring or naphthalene ring represented by AR may have a substituent. As the substituents, e.g., an alkyl group, a cycloalkyl group, an alkoxyl group, and a halogen atom are exemplified, and preferably a group having 8 or less carbon atoms.

A condensed ring of an alicyclic ring that may have a hetero atom on the skeleton may be formed on the benzene ring or naphthalene ring represented by AR.

The alkyl group or cycloalkyl group represented by Rn is preferably a group having 20 or less carbon atoms, e.g., a methyl group, an ethyl group, a propyl group, an isopropyl group, an n-butyl group, an isobutyl group, a t-butyl group, a pentyl group, a cyclopentyl group, a hexyl group, a cyclohexyl group, an octyl group, a dodecyl group and the like are exemplified.

The aryl group represented by Rn is preferably an aryl group having from 6 to 14 carbon atoms, e.g., a phenyl group, a xylyl group, a toluoyl group, a cumenyl group, a naphthyl group, and an anthracenyl group are exemplified.

The alkyl group, cycloalkyl group or aryl group represented by Rn may have a substituent, and as the preferred examples of the substituents that these groups may have, an alkoxyl group, a hydroxyl group, a halogen atom, a nitro group, an acyl group, an acyloxy group, an acylamino group, a sulfonylamino group, an alkylthio group, an arylthio group, an aralkylthio group, a thiophenecarbonyloxy group, a thiophenemethylcarbonyloxy group, a heterocyclic residue, e.g., a pyrrolidone residue, etc., etc., are exemplified, and preferably a substituent having 8 or less carbon atoms. Of the above substituents, an alkoxyl group, a hydroxyl group, a halogen atom, a nitro group, an acyl group, an acyloxy group, an acylamino group, and a sulfonylamino group are preferred.

The alkyl group or cycloalkyl group represented by A is preferably a group having 20 or less carbon atoms, e.g., a methyl group, an ethyl group, a propyl group, an isopropyl group, an n-butyl group, an isobutyl group, a t-butyl group, a pentyl group, a cyclopentyl group, a hexyl group, a cyclohexyl group, an octyl group, a dodecyl group and the like are exemplified. These groups may have a substituent, and as the preferred examples of the substituents that these groups may have, an alkoxyl group, a hydroxyl group, a halogen atom, a nitro group, an acyl group, an acyloxy group, an acylamino group, a sulfonylamino group, an alkylthio group, an arylthio group, an aralkylthio group, a thiophenecarbonyloxy group, a thiophenemethylcarbonyloxy group, a heterocyclic residue, e.g., a pyrrolidone residue, etc., etc., are exemplified, and preferably a substituent having 8 or less carbon atoms. Of the above groups, a CF₃ group, an alkyloxycarbonylmethyl group, an alkylcarbonyloxymethyl group, a hydroxymethyl group, an alkoxymethyl group, etc., are preferred.

As the halogen atom represented by A, a fluorine atom, a chlorine atom, a bromine atom and an iodine atom are exemplified, and a fluorine atom is preferred.

As the alkyl group contained in the alkyloxycarbonyl group represented by A, the same alkyl groups as represented by A above are exemplified.

The specific examples of the repeating units represented by formula (1) are shown below, but the invention is not restricted to these compounds.

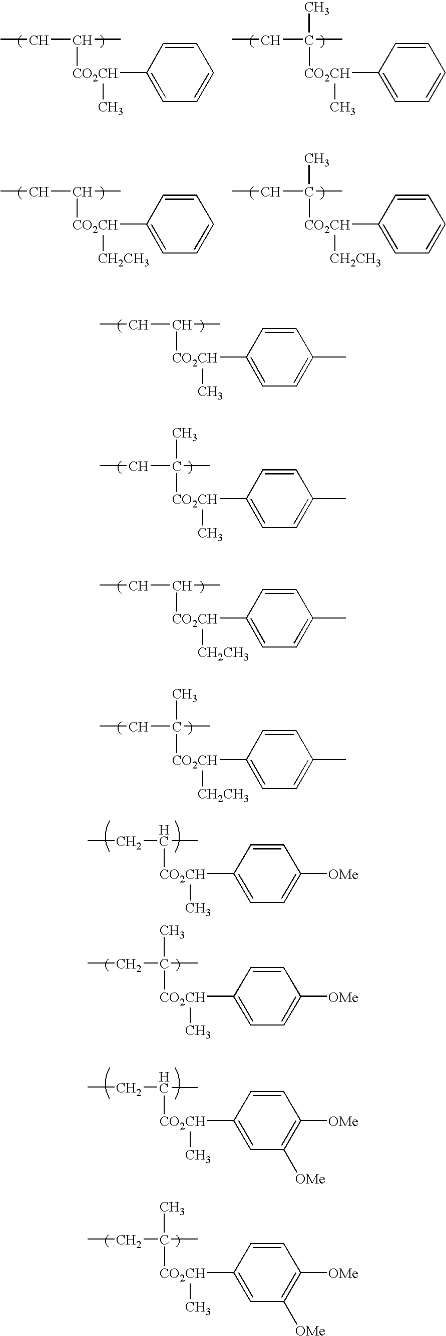

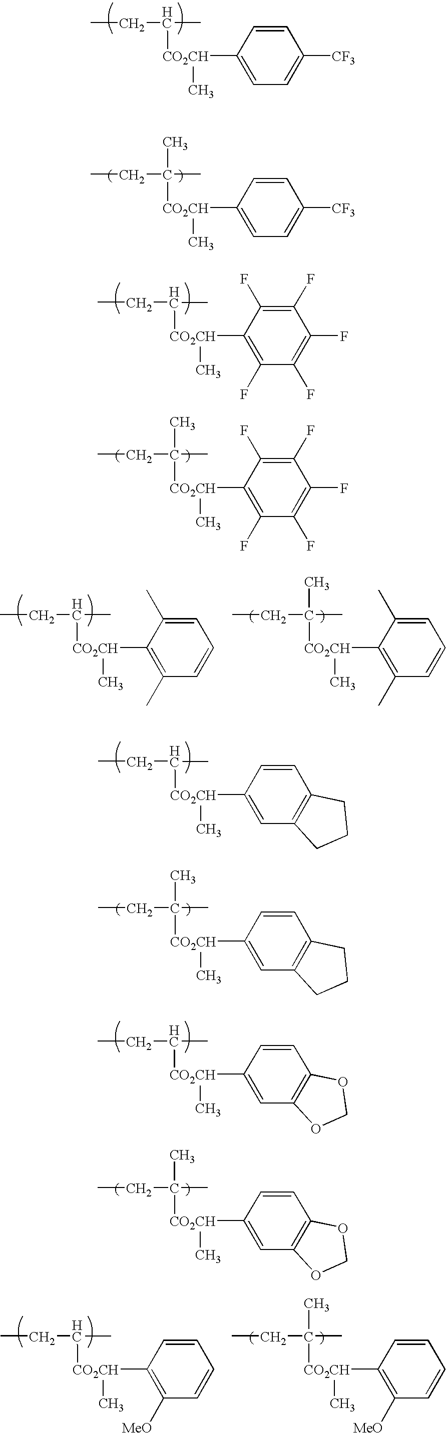

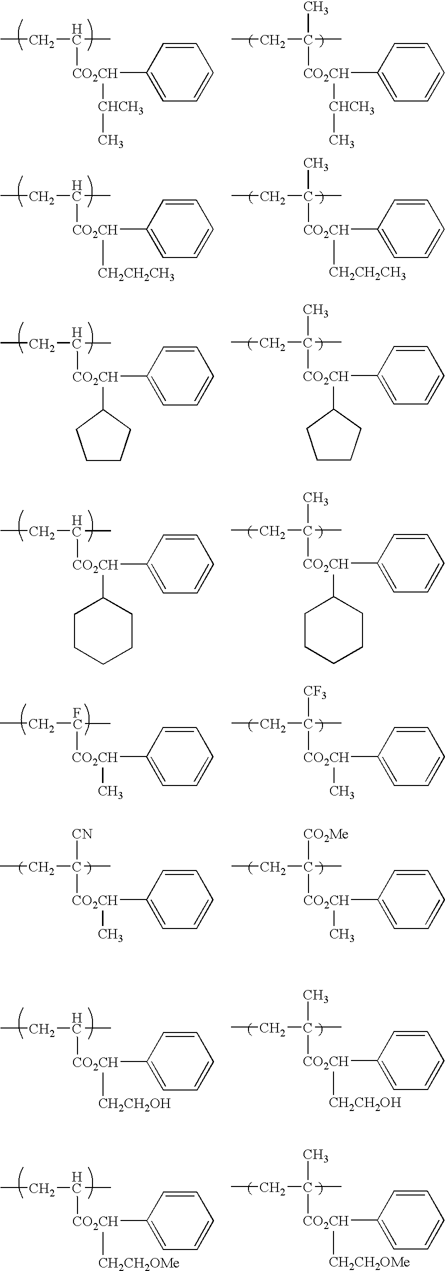

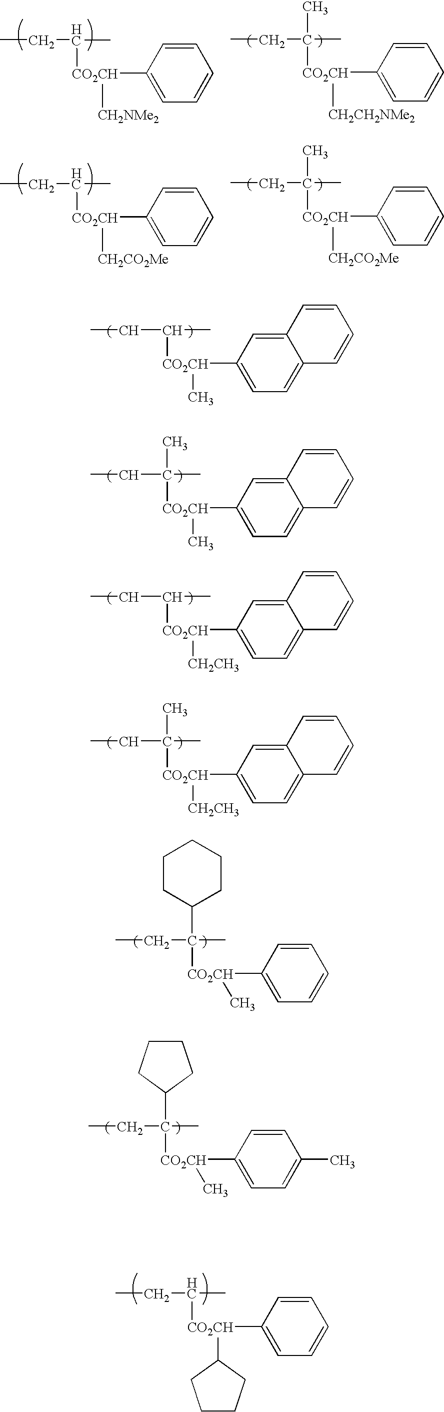

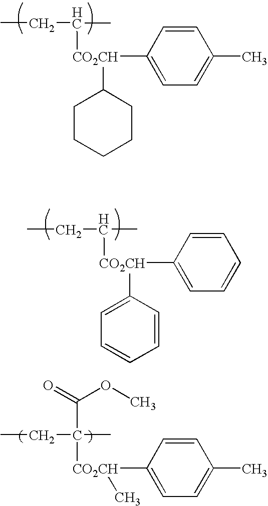

The monomer corresponding to the repeating unit represented by formula (1) can be synthesized according to known methods. For example, the monomer can be synthesized by esterifying secondary benzyl alcohol and (meth)acrylic chloride in a solvent, e.g., THF, acetone, methylene chloride, etc., in the presence of a basic catalyst such as triethylamine, pyridine, DBU, etc.

The resist composition in the invention contains an acid-decomposable crosslinking group together with the repeating unit represented by formula (1).

The acid-decomposable crosslinking group is a group that forms covalent bonding between the main chain and main chain of an uncrosslinked polymer to form a higher polymer than the uncrosslinked polymer, where the covalent bonding is cut by the action of an acid, and the molecular weight of the polymer returns to the molecular weight before crosslinking. The acid-decomposable crosslinking group may have a symmetric structure or may have an asymmetric structure. From the viewpoint of easiness of synthesis, a crosslinking group having a symmetric structure is preferred, but from the aspect of the improvement of resolution of the advantage of the invention, an asymmetric acid-decomposable crosslinking group is preferred.

An acetal crosslinking group represented by formula (2) will be described in detail below.

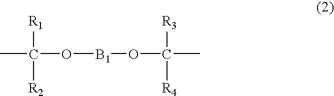

In formula (2), R₁, R₂, R₃ and R₄, which may be the same or different, each represents a hydrogen atom, an alkyl group or a cycloalkyl group. R₁ and R₂, or R₃ and R₄ may each form a ring. The terminal carbon atom in formula (2) is bonded to the oxygen atom of the carboxylic acid in the resin, or bonded to the oxygen atom of the phenolic hydroxyl group, or bonded to the oxygen atom of the alcoholic hydroxyl group.

B₁ represents a divalent organic group, in which one or two bonds with the contiguous oxygen atoms are cut by the action of an acid. The divalent organic group represented by B₁ is preferably an aliphatic or alicyclic saturated hydrocarbon group, an aromatic hydrocarbon group, or a heterocyclic group, each of which group may have a substituent, more preferably a straight chain alkyl group or monocyclic group having from 1 to 10 carbon atoms, an adamantyl group, or a benzene ring, and most preferably a dimethylcyclohexyl group.

The specific examples of the repeating units represented by formula (2) are shown below, but the invention is not restricted thereto.

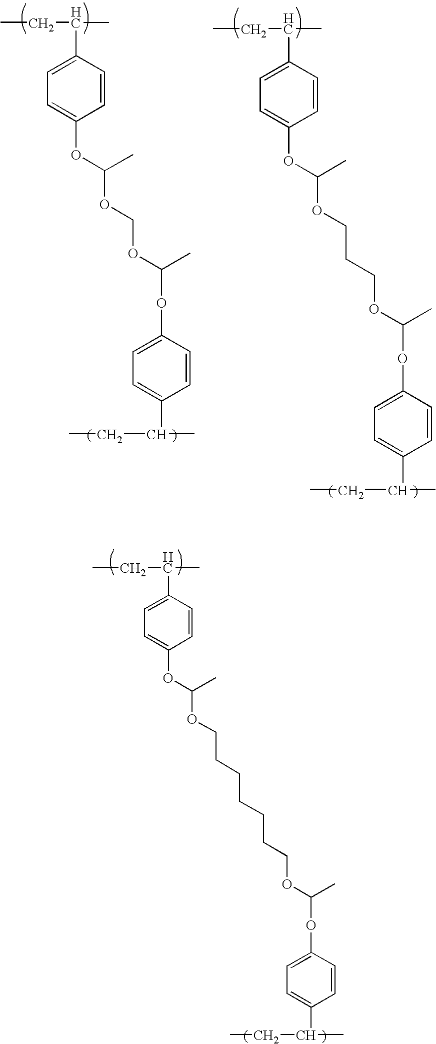

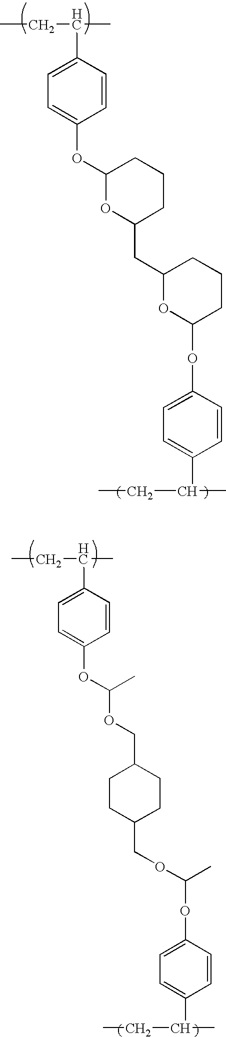

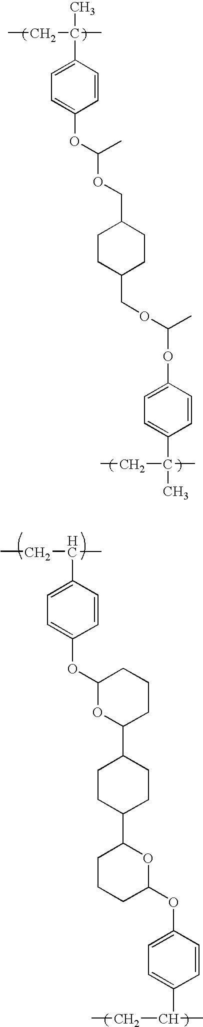

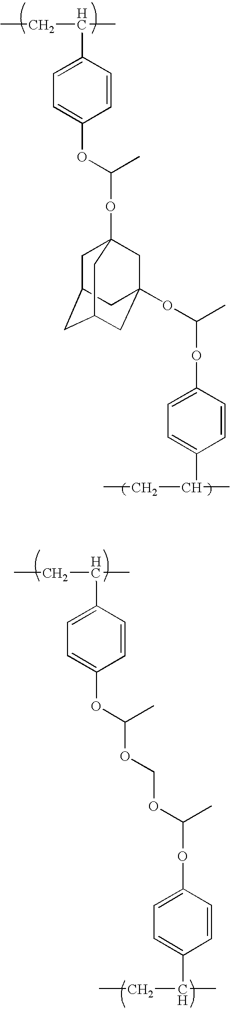

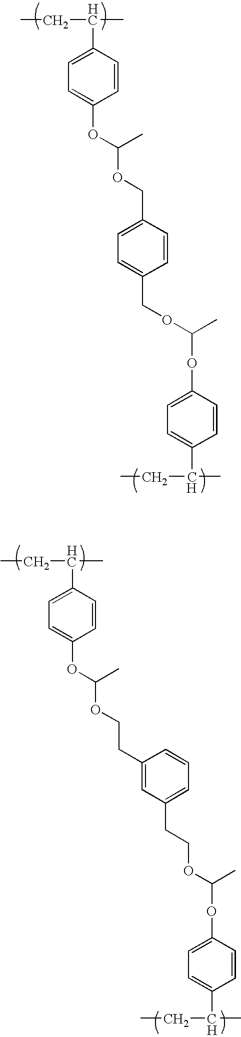

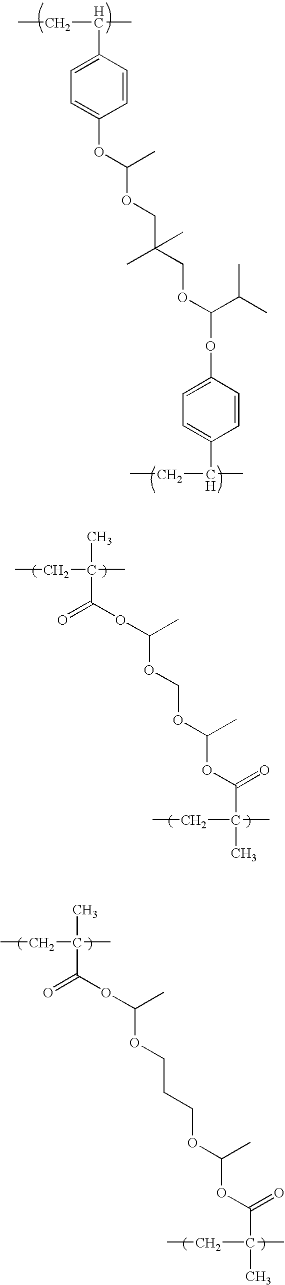

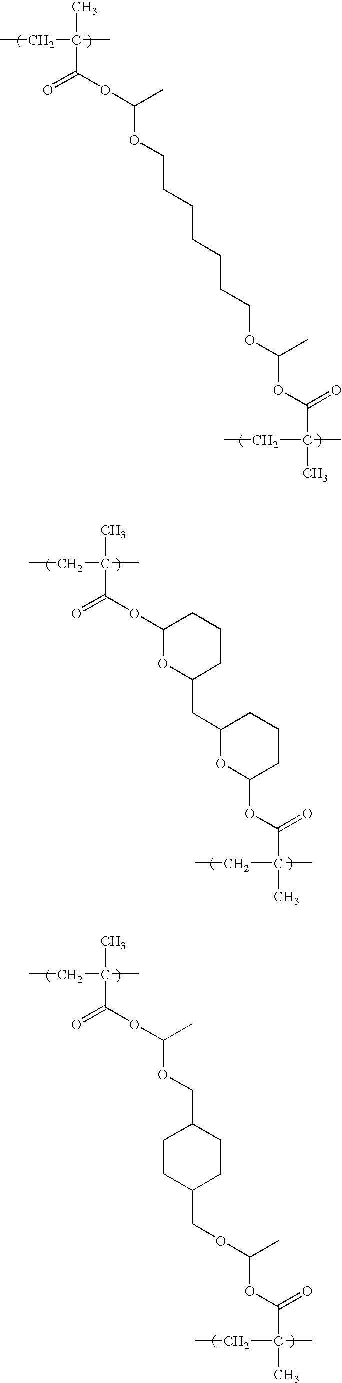

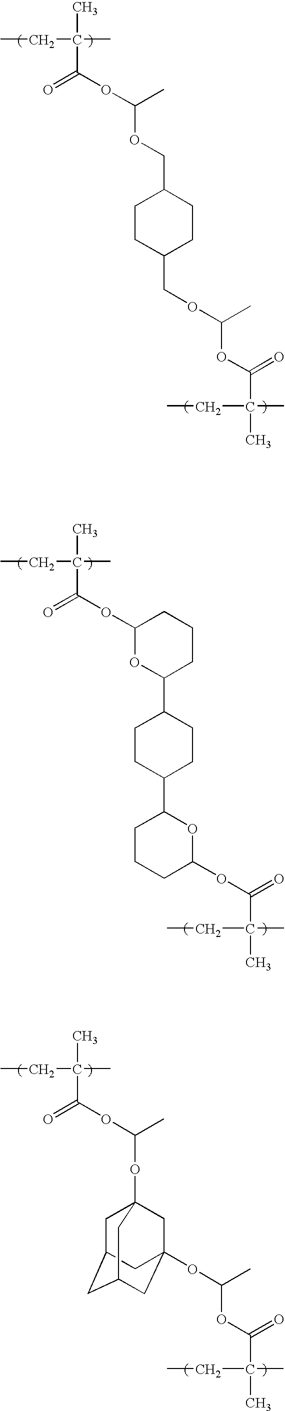

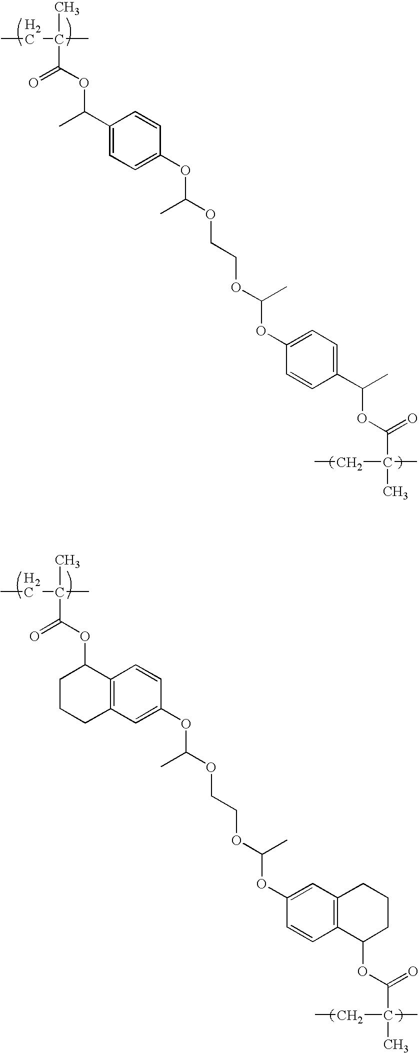

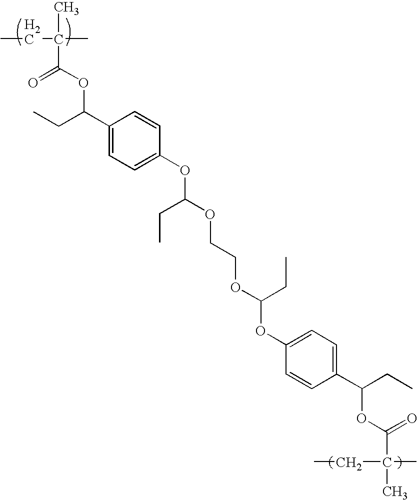

An acid-decomposable ester crosslinking group represented by formula (3) is described in detail below.

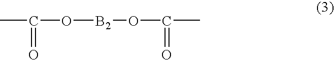

In formula (3), B₂ represents a divalent organic group, in which one or two bonds with the contiguous oxygen atoms are cut by the action of an acid. The divalent organic group represented by B₂ is preferably an aliphatic or alicyclic saturated hydrocarbon group, an aromatic hydrocarbon group, or a heterocyclic group, each of which group may have a substituent, more preferably a tertiary alkyl group, or a secondary benzyl group, and most preferably a secondary benzyl group.

The specific examples of the repeating units represented by formula (3) are shown below, but the invention is not restricted thereto.

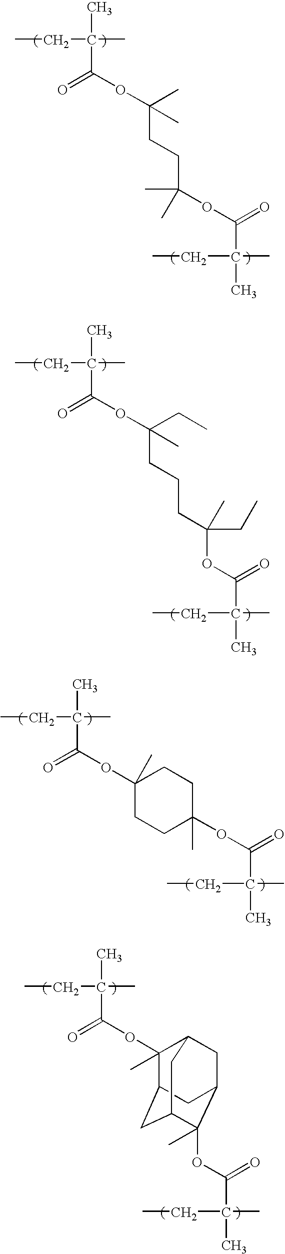

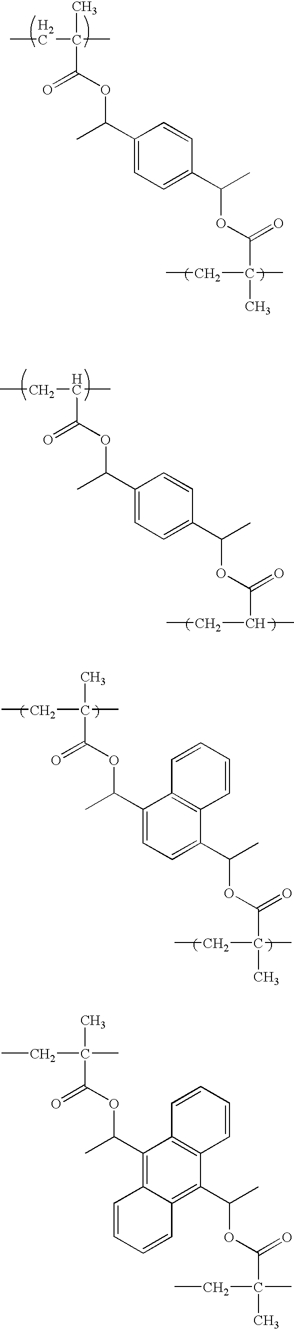

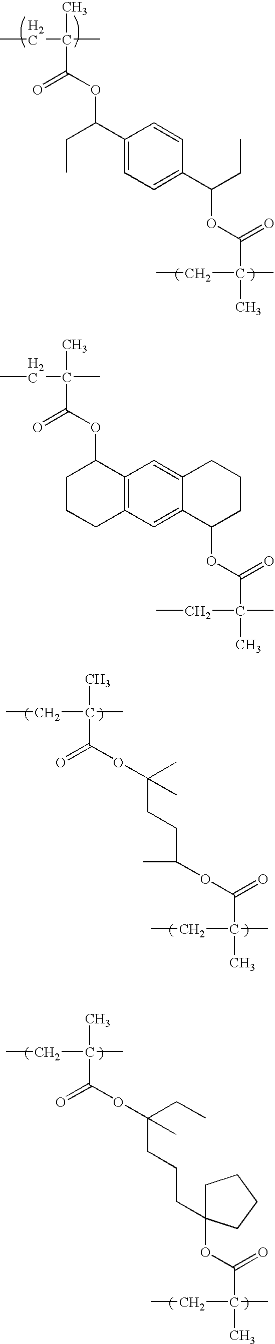

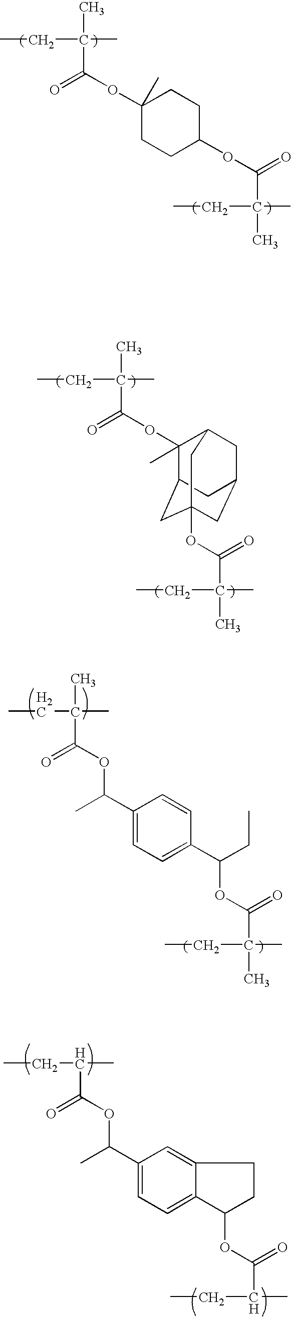

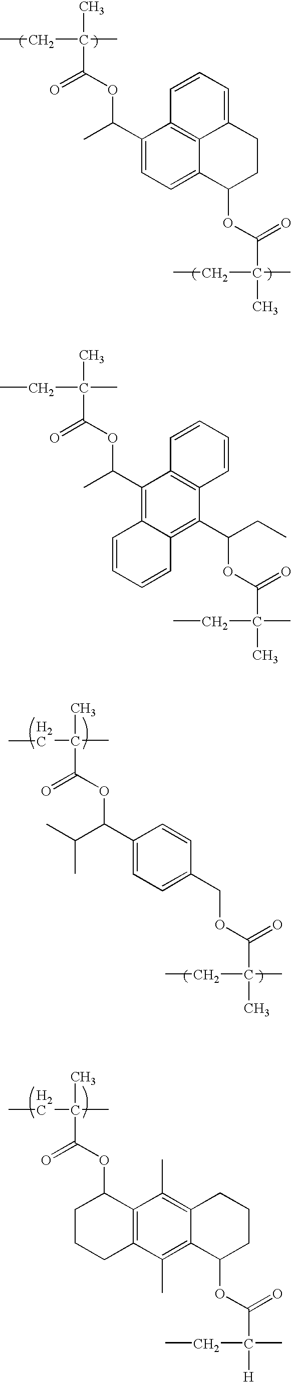

It is preferred for resin (A) to further contain a repeating unit represented by formula (4).

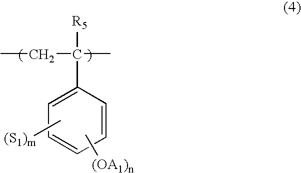

In formula (4), n represents an integer of from 0 to 3, m represents an integer of from 0 to 3, provided that m+n≦5.

A₁ represents a hydrogen atom, or a group containing a group capable of decomposing by the action of an acid, and when two or more A₁ are present, the A₁ may be the same or different.

As the group capable of decomposing by the action of an acid, tertiary alkyl groups, e.g., a t-butyl group, a t-amyl, etc., a t-butoxycarbonyl group, a t-butoxycarbonylmethyl group, and an acetal group, e.g., a group represented by —C(L₁)(L₂)-O-Z are exemplified.

L₁ and L₂, which may be the same or different, each represents a hydrogen atom, an alkyl group, a cycloalkyl group, or an aralkyl group.

Z represents an alkyl group, a cycloalkyl group, or an aralkyl group.

Z and L₁ may be bonded to each other to form a 5- or 6-membered ring.

S₁ represents a substituent, and when two or more S₁ are present, the S₁ may be the same or different.

R₅ represents a hydrogen atom, an alkyl group, a halogen atom, a cyano group, or an alkyloxycarbonyl group.

The group containing a group capable of decomposing by the action of an acid may be such a group that A₁ is desorbed by the action of an acid to generate a hydroxyl group in the repeating unit represented by formula (4) as a result, that is, the group may be an acid-decomposable group itself, or may be a group containing an acid-decomposable group, i.e., a group capable of decomposing by the action of an acid to generate an alkali-soluble group such as a hydroxyl group, a carboxyl group, etc., to the residue connected to the repeating unit.

A₁ preferably represents a hydrogen atom, an ethoxyethyl group, a propoxyethyl group, or a t-butyl group, and more preferably a group having a cyclic carbon structure. Here, a cyclic carbon structure is defined as a structure having an aliphatic ring, an aromatic ring, or a heterocyclic ring and, e.g., a cyclohexylethoxyethyl group, a phenoxyethoxyethyl group, a hydropyranyl group, and a thiophenylethoxyethyl group are exemplified.

As the substituent represented by S₁, e.g., an alkyl group, a cycloalkyl group, an alkoxyl group, an acyl group, an acyloxy group, an aryl group, an aryloxy group, an aralkyl group, an aralkyloxy group, a hydroxyl group, a halogen atom, a cyano group, a nitro group, a sulfonylamino group, an alkylthio group, and an arylthio group are exemplified, and preferably a substituent having 8 or less carbon atoms.

For example, as the alkyl group and the cycloalkyl group, a straight chain or branched alkyl group and cycloalkyl group having from 1 to 20 carbon atoms, e.g., a methyl group, an ethyl group, a propyl group, an isopropyl group, an n-butyl group, an isobutyl group, a t-butyl group, a pentyl group, a cyclopentyl group, a hexyl group, a cyclohexyl group, an octyl group, and a dodecyl group are preferred. These groups may further have a substituent.

As the examples of the substituents that the substituent represented by S₁ may further have, an alkyl group, an alkoxyl group, a hydroxyl group, a halogen atom, a nitro group, an acyl group, an acyloxy group, an acylamino group, a sulfonylamino group, an alkylthio group, an arylthio group, an aralkylthio group, a thiophenecarbonyloxy group, a thiophenemethylcarbonyloxy group, and a heterocyclic residue, e.g., a pyrrolidone residue are exemplified, and preferably a substituent having 12 or less carbon atoms.

As the examples of the alkyl groups having a substituent, e.g., a cyclohexylethyl group, an alkylcarbonyloxymethyl group, an alkylcarbonyloxyethyl group, a cycloalkylcarbonyloxymethyl group, a cycloalkylcarbonyloxyethyl group, an arylcarbonyloxyethyl group, an aralkylcarbonyloxyethyl group, an alkyloxymethyl group, a cycloalkyloxymethyl group, an aryloxymethyl group, an aralkyloxymethyl group, an alkyloxyethyl group, a cycloalkyloxyethyl group, an aryloxyethyl group, an aralkyloxyethyl group, an alkylthiomethyl group, a cycloalkylthiomethyl group, an arylthiomethyl group, an aralkylthiomethyl group, an alkylthioethyl group, a cycloalkylthioethyl group, an arylthioethyl group, and an aralkylthioethyl group are exemplified.

The alkyl group and cycloalkyl group in these groups are not especially restricted, and they may have the substituents of the above alkyl group, cycloalkyl group and alkoxyl group.

As the examples of the alkylcarbonyloxyethyl group and cycloalkylcarbonyloxyethyl group, a cyclohexylcarbonyloxyethyl group, a t-butylcyclohexylcarbonyloxyethyl group, and an n-butylcyclohexylcarbonyloxyethyl group are exemplified.

The aryl group is also not especially restricted, but generally aryl groups having from 6 to 14 carbon atoms, e.g., a phenyl group, a xylyl group, a toluoyl group, a cumenyl group, a naphthyl group, and an anthracenyl group are exemplified, and these groups may further have the substituents of the above alkyl group, cycloalkyl group and alkoxyl group.

As the examples of the aryloxyethyl group, a phenyloxyethyl group and a cyclohexylphenyloxyethyl group can be exemplified. These groups may further have a substituent.

The aralkyl group is also not especially restricted, and a benzyl group can be exemplified.

As the example of the aralkylcarbonyloxyethyl group, a benzylcarbonyloxyethyl group can be exemplified, which group may further have a substituent.

As the aralkyl groups represented by L₁, L₂ and Z. e.g., aralkyl groups having from 7 to 15 carbon atoms are exemplified. These groups may have a substituent.

As preferred substituents of the aralkyl groups, e.g., an alkoxyl group, a hydroxyl group, a halogen atom, a nitro group, an acyl group, an acylamino group, a sulfonylamino group, an alkylthio group, an arylthio group, and an aralkylthio group can be exemplified. As the aralkyl group having a substituent, e.g., an alkoxybenzyl group, a hydroxybenzyl group, and a phenylthiophenethyl group can be exemplified.

The range of the number of carbon atoms of the substituents that the aralkyl group represented by L₁, L₂ and Z may have is preferably 12 or less.

As the 5- or 6-membered ring formed by Z and L₁ together by bonding, a tetrahydropyran ring and a tetrahydrofuran ring are exemplified.

In the invention, Z preferably represents a straight chain or branched alkyl group, by which the advantage of the invention becomes further conspicuous.

The monomer corresponding to the repeating unit represented by formula (4) can be synthesized as follows. For example, the monomer can be synthesized by acetalizing a hydroxy-substituted styrene monomer and a vinyl ether compound in a solvent, e.g., THF, methylene chloride, etc., in the presence of an acid catalyst such as p-toluenesulfonic acid, pyridine p-toluenesulfonate, etc., or can be synthesized by using t-butyl dicarbonate and t-Boc protecting in the presence of a basic catalyst such as triethylamine, pyridine, DBU, etc. Commercially available products may be used.

The specific examples of the repeating units represented by formula (4) are shown below, but the invention is not restricted thereto.

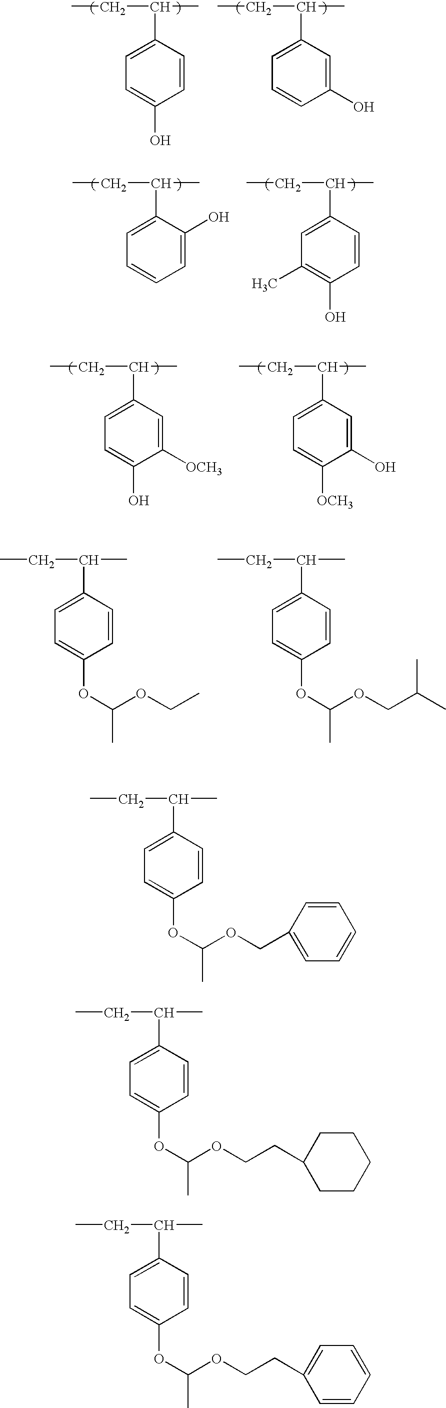

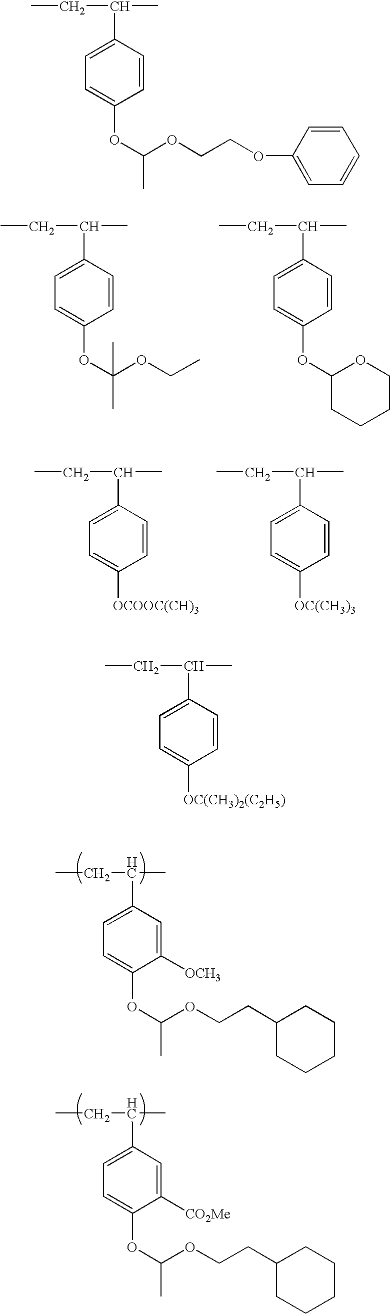

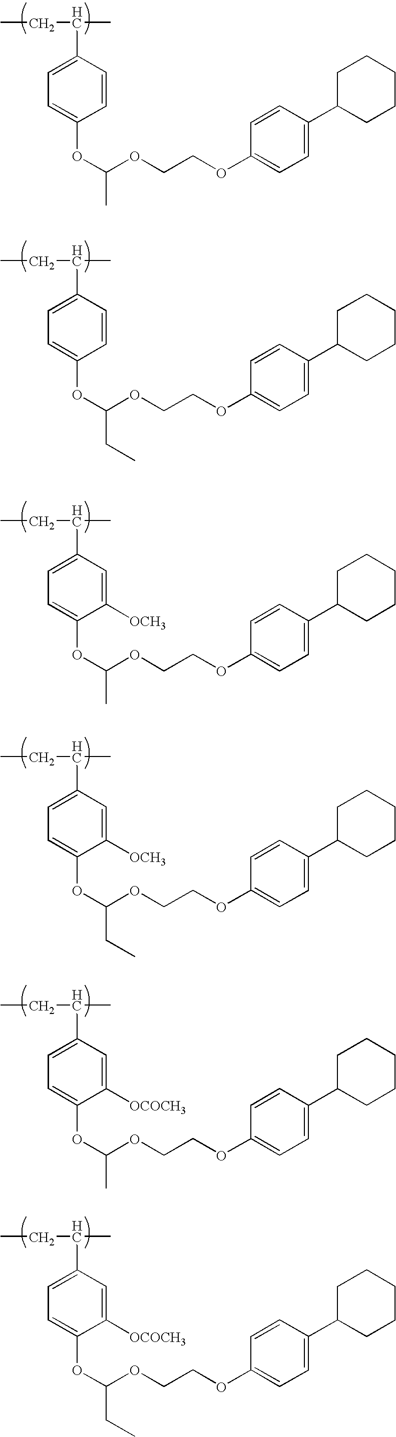

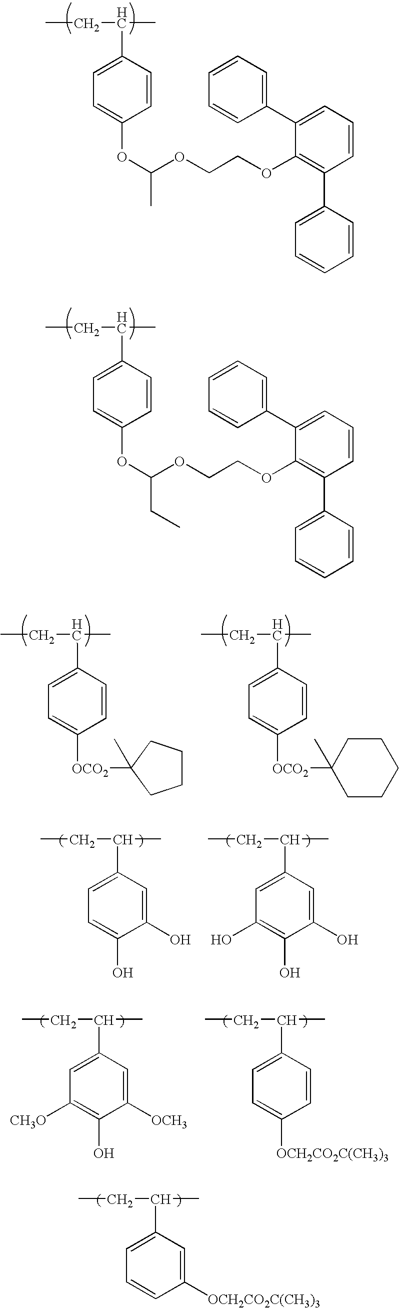

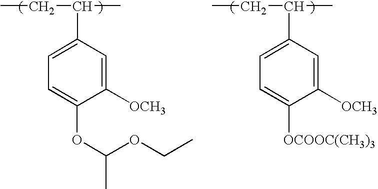

It is also preferred for resin (A) to further have a repeating unit represented by formula (5).

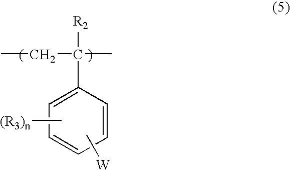

In formula (5), R₂ represents a hydrogen atom, a methyl group, a cyano group, a halogen atom, or a perfluoro group (having from 1 to 4 carbon atoms).

R₃ represents an alkyl group, a halogen atom, an aryl group, an alkoxyl group, or an acyl group.

n represents an integer of from 0 to 4.

W represents a group not capable of decomposing by the action of an acid.

W represents a group not capable of decomposing by the action of an acid (it is also referred to as “an acid stable group”), i.e., W does not contain a group decomposing by the action of an acid. As the specific examples of W, a hydrogen atom, a halogen atom, an alkyl group, a cycloalkyl group, an alkenyl group, an aryl group, an acyl group, an alkylamido group, an arylamidomethyl group and an arylamido group are exemplified. As the preferred acid stable groups, an acyl group and an alkylamido group are exemplified, and the more preferred groups are an acyl group, an alkylcarbonyloxy group, an alkyloxy group, a cycloalkyloxy group, and an aryloxy group.

As the alkyl group in the acid stable group represented by W, an alkyl group having from 1 to 4 carbon atoms such as a methyl group, an ethyl group, a propyl group, an n-butyl group, a sec-butyl group, and a t-butyl group are preferred, as the cycloalkyl group, a cycloalkyl group having from 3 to 10 carbon atoms such as a cyclopropyl group, a cyclobutyl group, a cyclohexyl group, and an adamantyl group are preferred, as the alkenyl group, an alkenyl group having from 2 to 4 carbon atoms such as a vinyl group, a propenyl group, an allyl group, and a butenyl group are preferred, and as the aryl group, an aryl group having from 6 to 14 carbon atoms such as a phenyl group, a xylyl group, a toluoyl group, a cumenyl group, a naphthyl group, and an anthracenyl group are preferred. W may be present at any position on a benzene ring, but the meta-position or para-position of a styrene skeleton is preferred, and the para-position is especially preferred. The specific examples of the repeating units represented by formula (5) are shown below, but the invention is not restricted thereto.

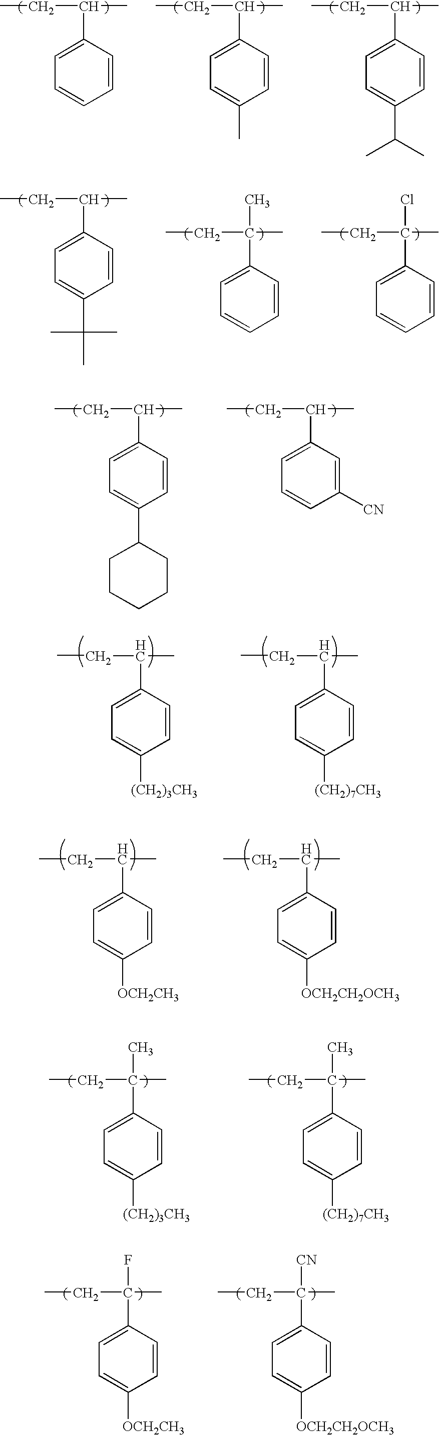

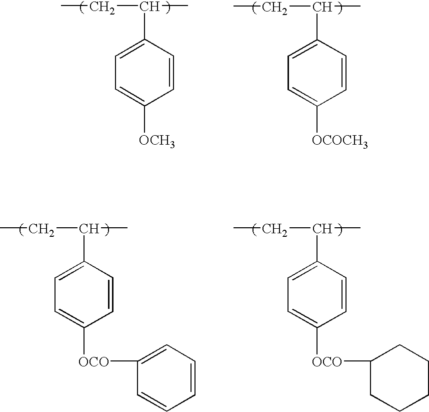

It is also preferred for resin (A) to have a repeating unit comprising a (meth)acrylic acid derivative not capable of decomposing by the action of an acid. The specific examples the repeating units are shown below, but the invention is not restricted thereto.

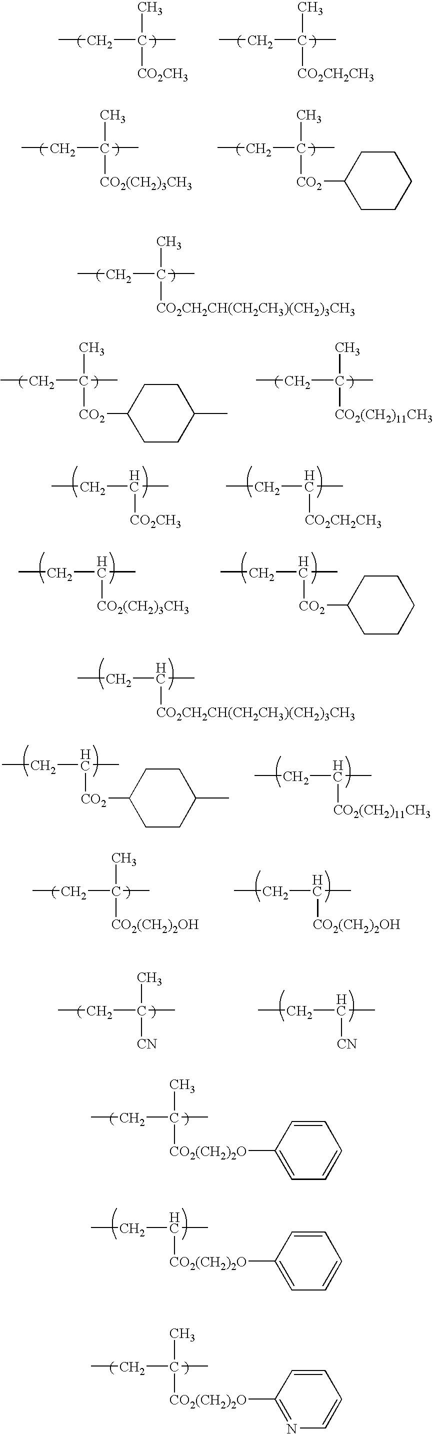

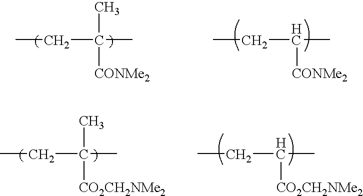

Since the repeating unit represented by formula (1) is decomposed by the action of an acid to generate a carboxyl group, resin (A) is a resin capable of increasing the solubility in an alkali developing solution by the action of an acid (an acid-decomposable resin). It is preferred to contain a group capable of decomposing by the action of an acid to generate an alkali-soluble group (an acid-decomposable group) in an arbitrary repeating unit.

As described above, an acid-decomposable group may be contained in, besides the repeating unit represented by formula (1), other repeating unit, e.g., the repeating unit represented by formula (4).

As the acid-decomposable group, besides the above described groups, for example, a group represented by formula —C(═O)—X₁—R₀ can be exemplified.

In the formula, R₀ represents a tertiary alkyl group, e.g., a t-butyl group, a t-amyl group, etc., an isoboronyl group, a 1-alkoxyethyl group, e.g., a 1-ethoxyethyl group, a 1-butoxyethyl group, a 1-isobutoxyethyl group, a 1-cyclohexyloxyethyl group, etc., an alkoxymethyl group, e.g., a 1-methoxymethyl group, a 1-ethoxymethyl group, etc., a 3-oxoalkyl group, a tetrahydropyranyl group, a tetrahydrofuranyl group, a trialkylsilyl ester group, a 3-oxocyclohexyl ester group, a 2-methyl-2-adamantyl group, a mevalonic lactone residue, etc. X₁ represents an oxygen atom, a sulfur atom, —NH—, —NHSO₂— or —NHSO₂NH—.

The content of the repeating unit having an acid-decomposable group in resin (A) is preferably from 1 to 50 mol % in all the repeating units, more preferably from 3 to 40 mol %, and especially preferably from 5 to 30 mol %.

The content of the repeating unit represented by formula (1) in resin (A) is preferably from 10 to 60 mol % in all the repeating units, more preferably from 15 to 50 mol %, and especially preferably from 20 to 40 mol %.

The content of the repeating unit having a crosslinking group represented by formula (2) or (3) in resin (A) is preferably from 1 to 20 mol % in all the repeating units, more preferably from 3 to 10 mol %, and especially preferably from 5 to 8 mol %. In connection with the repeating unit having a crosslinking group, repeating units as a whole connected by one crosslinking group is taken as one unit.

The content of the repeating unit represented by formula (4) in resin (A) is preferably from 40 to 90 mol % in all the repeating units, more preferably from 50 to 85 mol %, and especially preferably from 60 to 80 mol %.

Resin (A) may further have the repeating unit represented by formula (5), and to contain the repeating unit is preferred in view of the improvement of film quality and the restraint of film reduction of an unexposed area. The content of the repeating unit represented by formula (5) in resin (A) is preferably from 0 to 30 mol % in all the repeating units, more preferably from 0 to 20 mol %, and especially preferably from 0 to 10 mol %.

Further, for maintaining a good developability in an alkali developing solution, resin (A) may be copolymerized with appropriate other polymerizable monomers so that an alkali-soluble group, e.g., a phenolic hydroxyl group or a carboxyl group can be introduced, or resin (A) may be copolymerized with hydrophobic other polymerizable monomers such as alkyl acrylate or alkyl methacrylate for the purpose of the improvement of film quality.

Resin (A) containing an acid-decomposable crosslinking group can be obtained, in the case of acid-decomposable acetal crosslinking, by dehydration and in the presence of an acid catalyst by the reaction of a resin before crosslinking with divinyl ether as shown below. In the case of acid-decomposable ester crosslinking, resin (A) can be obtained by polymerization of a bifunctional monomer having polymerizable olefin as shown below in the presence of a polymerization initiator.

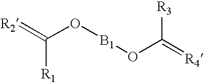

In the formula, R₂′ and R₄′ each represents a group capable of becoming R₂ and R₄ by crosslinking.

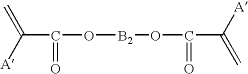

In the formula, A′ represents a hydrogen atom, an alkyl group, a cycloalkyl group, a halogen atom, a cyano group, or an alkyloxycarbonyl group. The details are the same as A in formula (1).

In the case of acetal crosslinking (crosslinking with the acetal crosslinking group represented by formula (2)), a resin before crosslinking is synthesized by known radical polymerization, and the obtained resin is subjected to crosslinking by high molecular reaction. The weight average molecular weight (Mw) of the resin before crosslinking is preferably from 1,500 to 5,000, and more preferably from 1,500 to 3,000. The resin before crosslinking has a hydroxyl group derived from phenol or a hydroxyl group derived from carboxylic acid.

In the case of ester crosslinking (crosslinking with the ester crosslinking group represented by formula (3)), a corresponding bifunctional monomer is blended with other monomer at the time of polymerization and crosslinked simultaneously with the polymerization.

The weight average molecular weight (Mw) of resin (A) is preferably in the range of from 1,000 to 50,000 in respective cases, and more preferably from 3,000 to 30,000. The polydispersity (Mw/Mn) is preferably from 1.0 to 5.0, more preferably from 1.0 to 3.0, and especially preferably from 1.0 to 2.0.

Here, the weight average molecular weight is defined as the polystyrene equivalent value by gel permeation chromatography.

Resin (A) having the polydispersity (Mw/Mn) of from 1.5 to 2.0 can be synthesized by radical polymerization with an azo polymerization initiator. Resin (A) having more preferred polydispersity of from 1.0 to 1.5 can be synthesized by living radical polymerization.

Resin (A) may be used in combination of two or more kinds.

The addition amount of resin (A) is generally from 10 to 96 mass % as total amount based on all the solids content of the resist composition, preferably from 15 to 96 mass %, and especially preferably from 20 to 95 mass %.

The specific examples of resins (A) having the repeating unit represented by formula (1) and the acid-decomposable crosslinking group represented by formula (2) are shown below, but the invention is not restricted thereto.

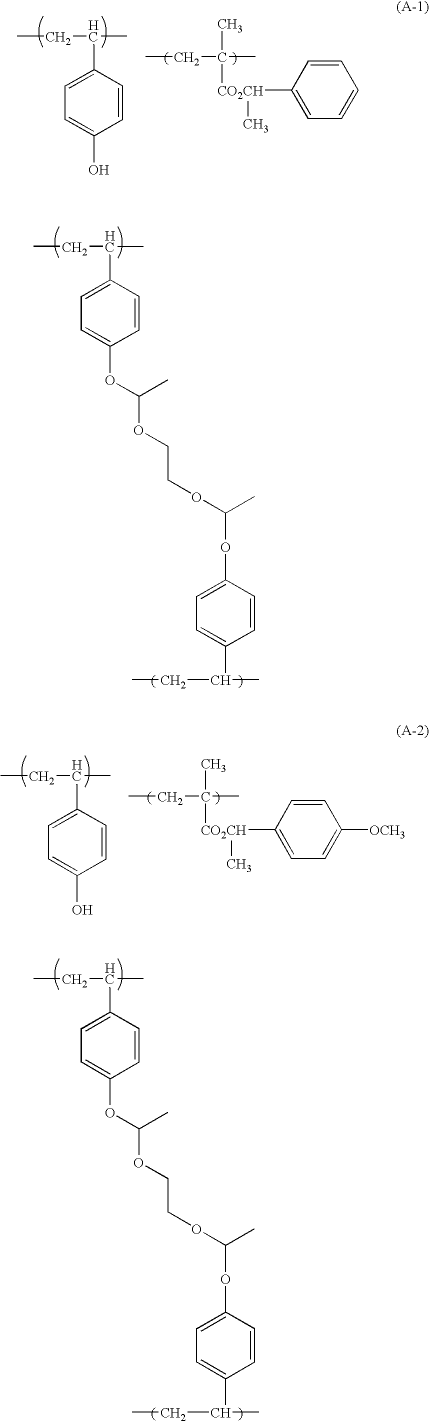

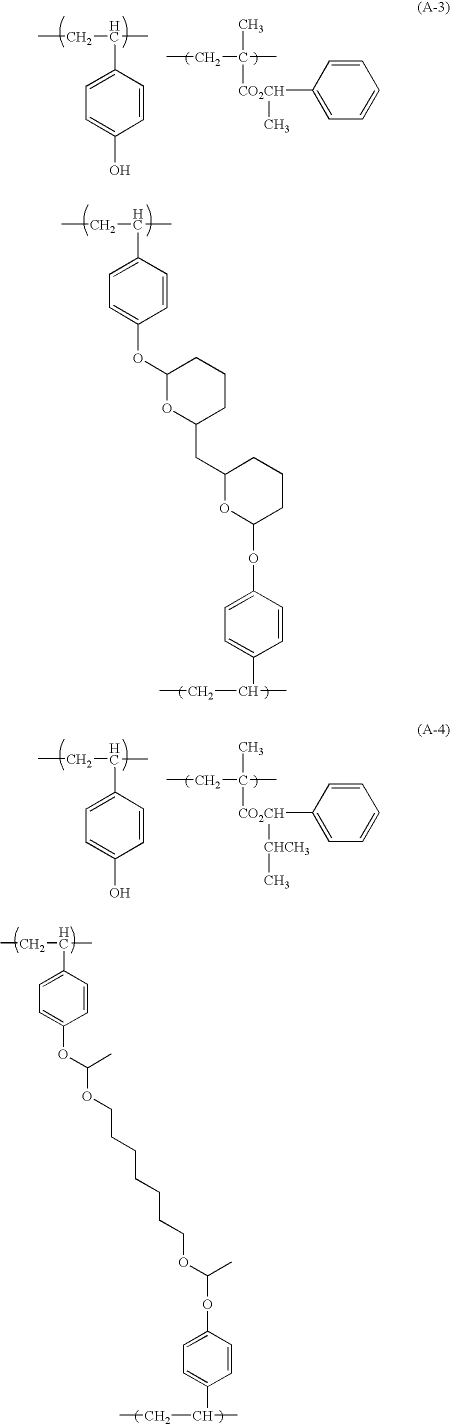

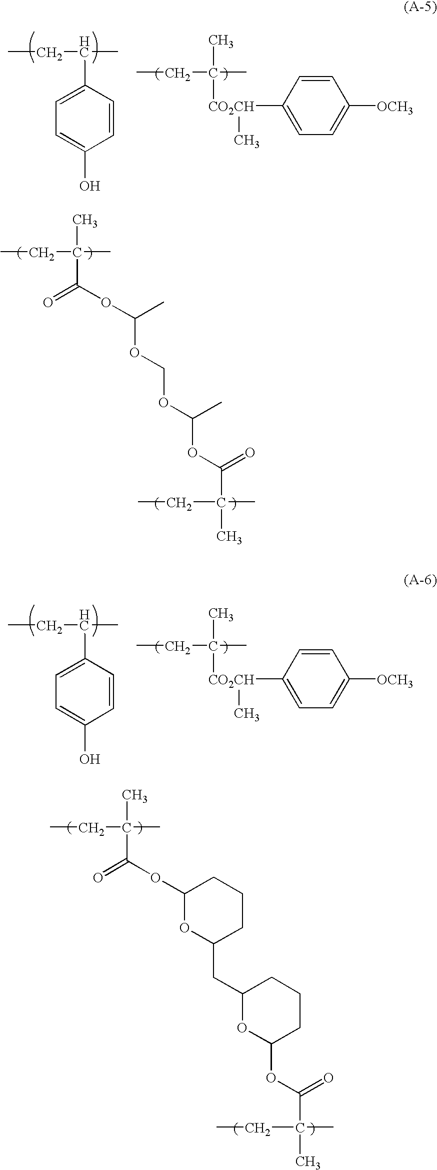

The specific examples of resins (A) having the repeating unit represented by formula (1) and the acid-decomposable crosslinking group represented by formula (3) are shown below, but the invention is not restricted thereto. 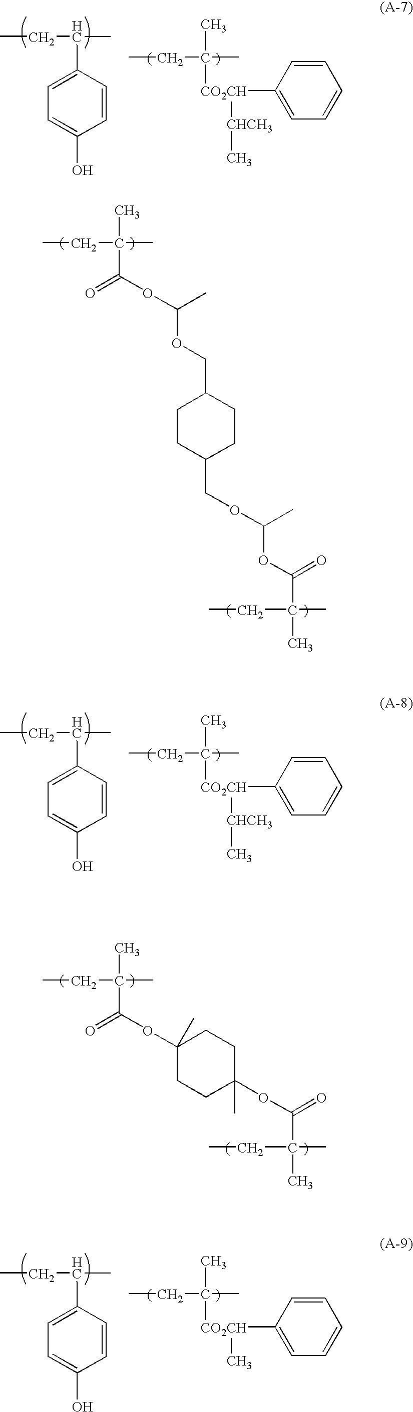 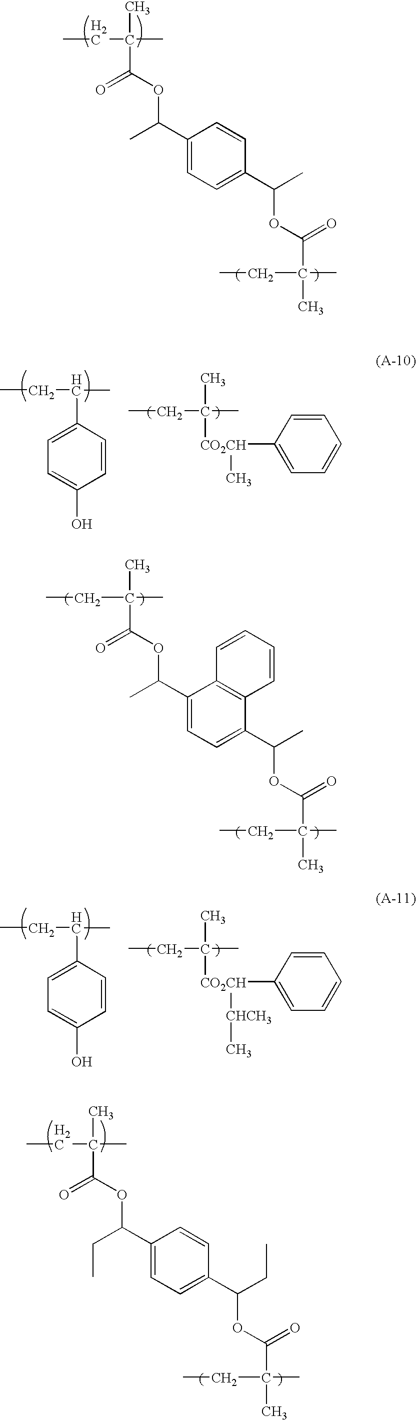 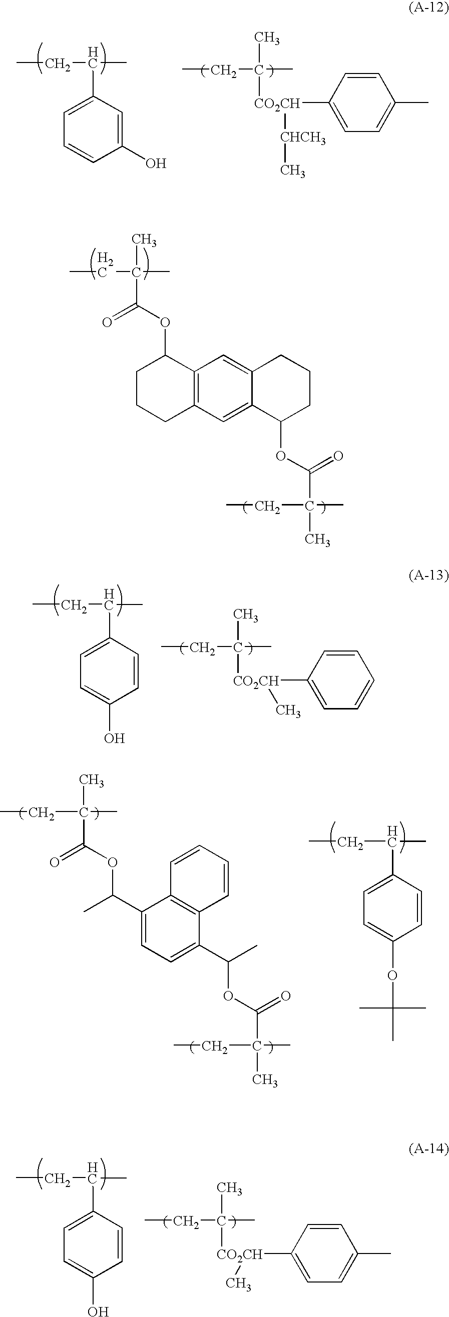 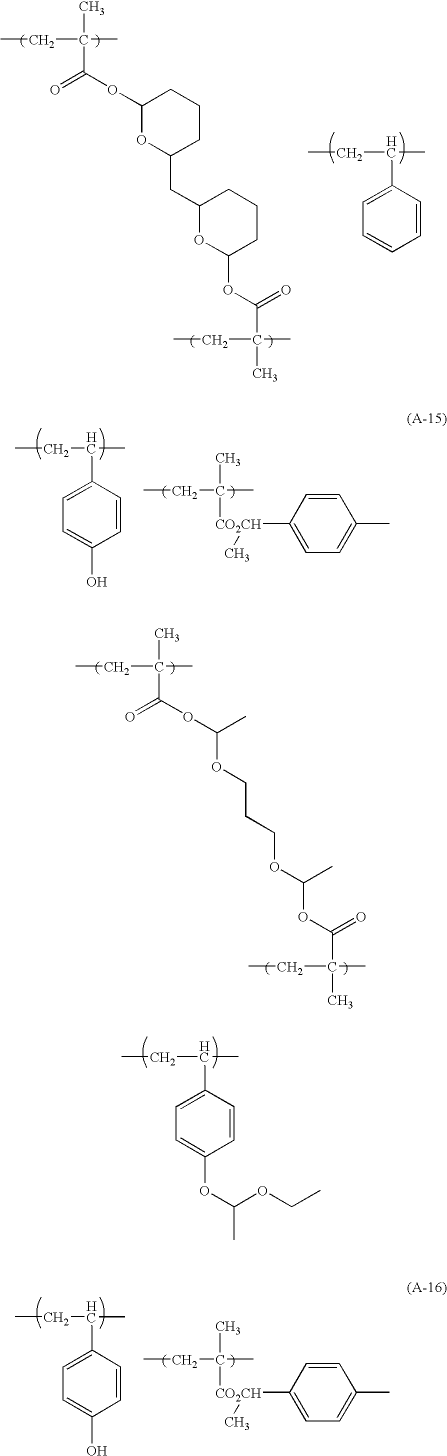 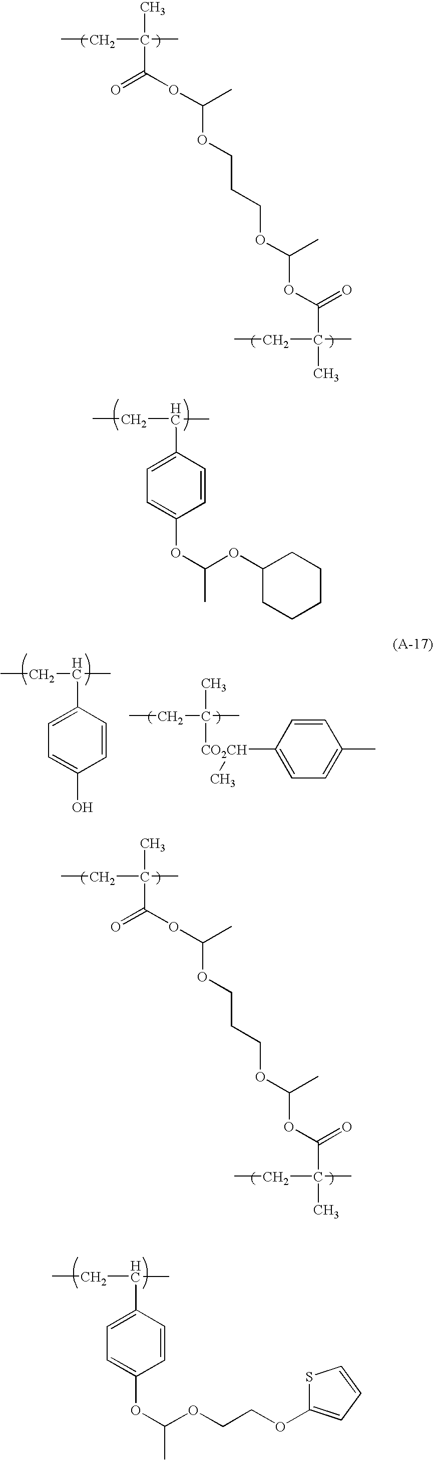
[2] A Compound Capable of Generating an Acid Upon Irradiation with an Actinic Ray or Radiation:

In the resist composition in the invention, as the compound capable of generating an acid upon irradiation with an actinic ray or radiation (an acid generator), known compounds can be used, but it is preferred to use a compound capable of generating a sulfonic acid upon irradiation with an actinic ray or radiation (a sulfonic acid generator) and/or a compound capable of generating a carboxylic acid upon irradiation with an actinic ray or radiation (a carboxylic acid generator).

Compound (B) Capable of Generating a Sulfonic Acid Upon Irradiation with an Actinic Ray or Radiation:

A compound capable of generating a sulfonic acid upon irradiation with an actinic ray or radiation (referred to as compound (B) or a sulfonic acid generator) contained in the resist composition in the invention is a compound capable of generating a sulfonic acid upon irradiation with an actinic ray or radiation such as KrF excimer laser beams, electron beams or EUV and, for example, diazonium salt, phosphonium salt, sulfonium salt, iodonium salt, imidosulfonate, oximesulfonate, diazodisulfone, disulfone, o-nitrobenzylsulfonate, etc., are exemplified as compound (B).

Further, compounds obtained by introducing a group or a compound capable of generating an acid upon irradiation with an actinic ray or radiation to the main chain or side chain of polymers, for example, the compounds disclosed in U.S. Pat. No. 3,849,137, German Patent 3,914,407, JP-A-63-26653, JP-A-55-164824, JP-A-62-69263, JP-A-63-146038, JP-A-63-163452, JP-A-62-153853, and JP-A-63-146029 can be used.

The compounds generating an acid by the action of light as disclosed in U.S. Pat. No. 3,779,778 and EP 126712 can also be used.

In the invention, as preferred sulfonic acid generators from the viewpoint of the improvement of image performances such as resolution and pattern form, sulfonium salt, iodonium salt, imidosulfonate, oximesulfonate, diazodisulfone and disulfone can be exemplified.

Of these, especially preferred examples are shown below.

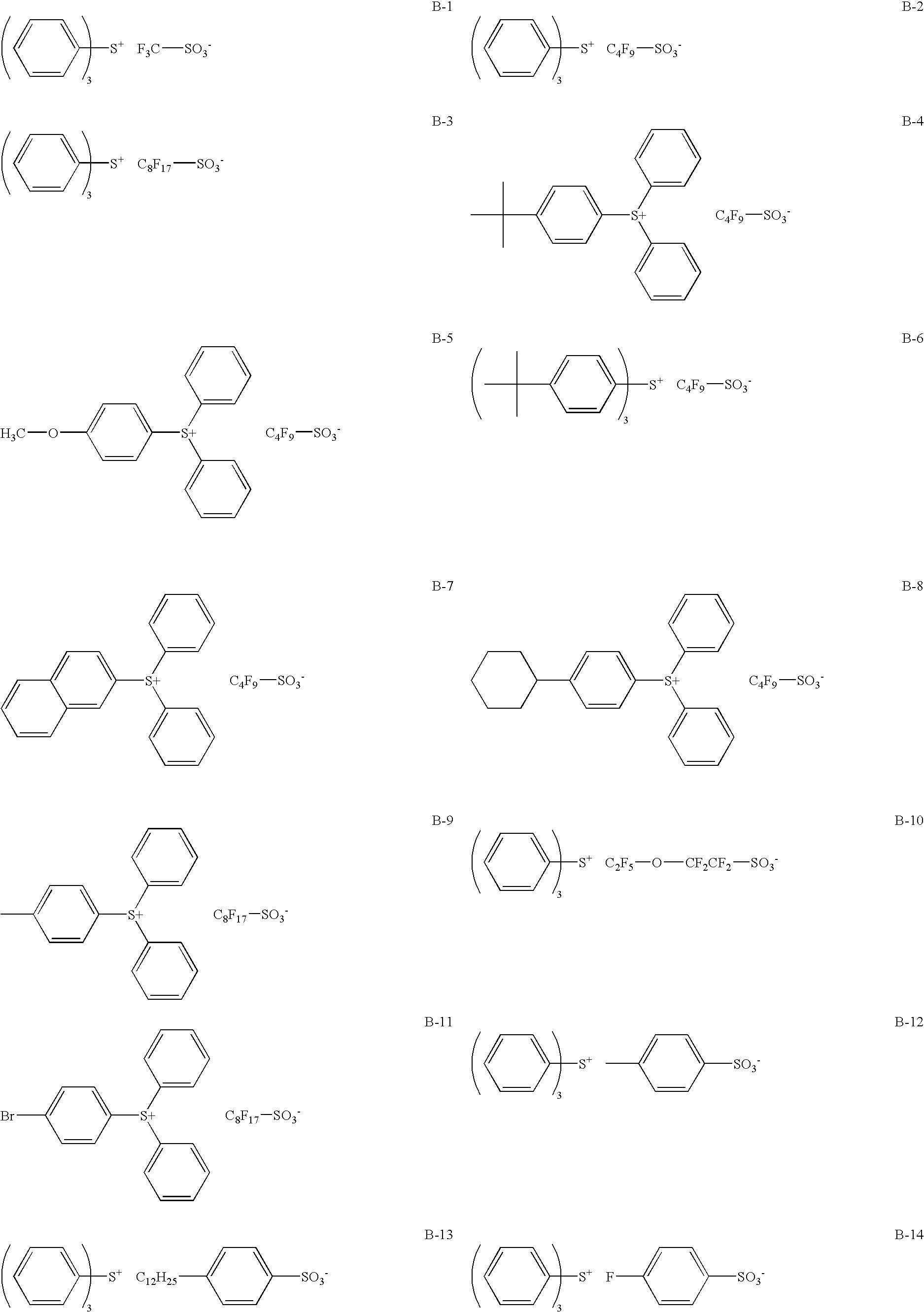

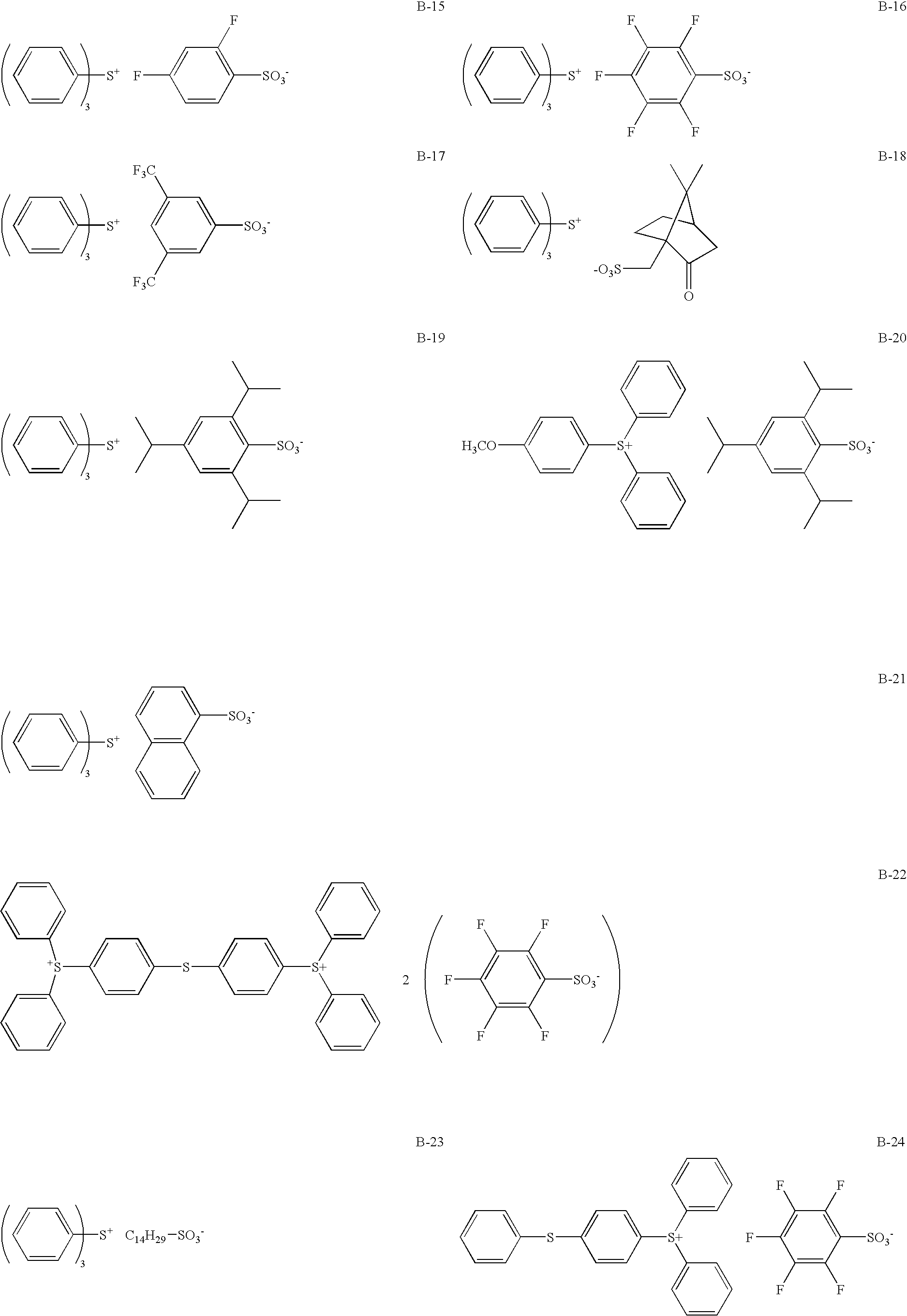

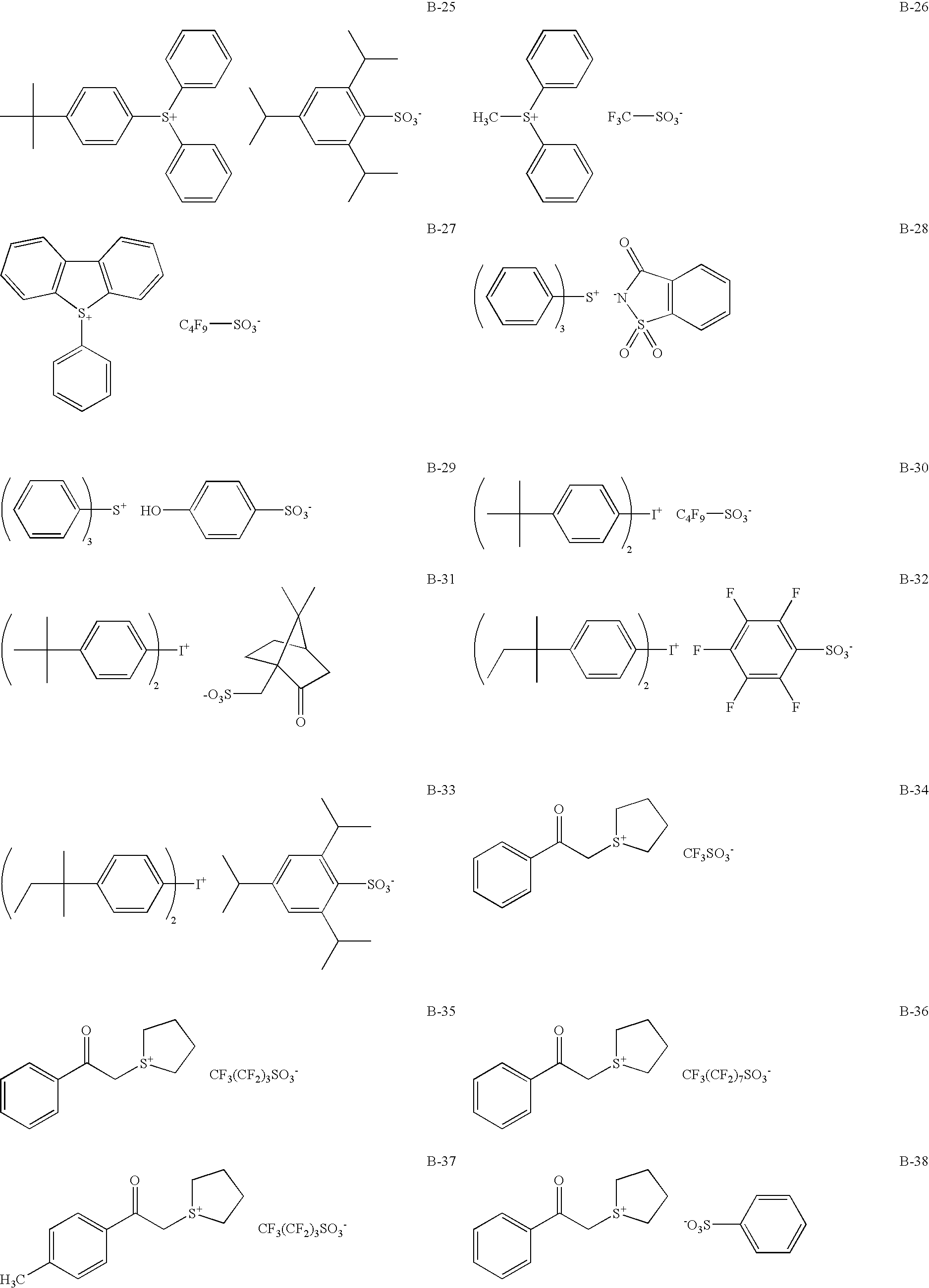

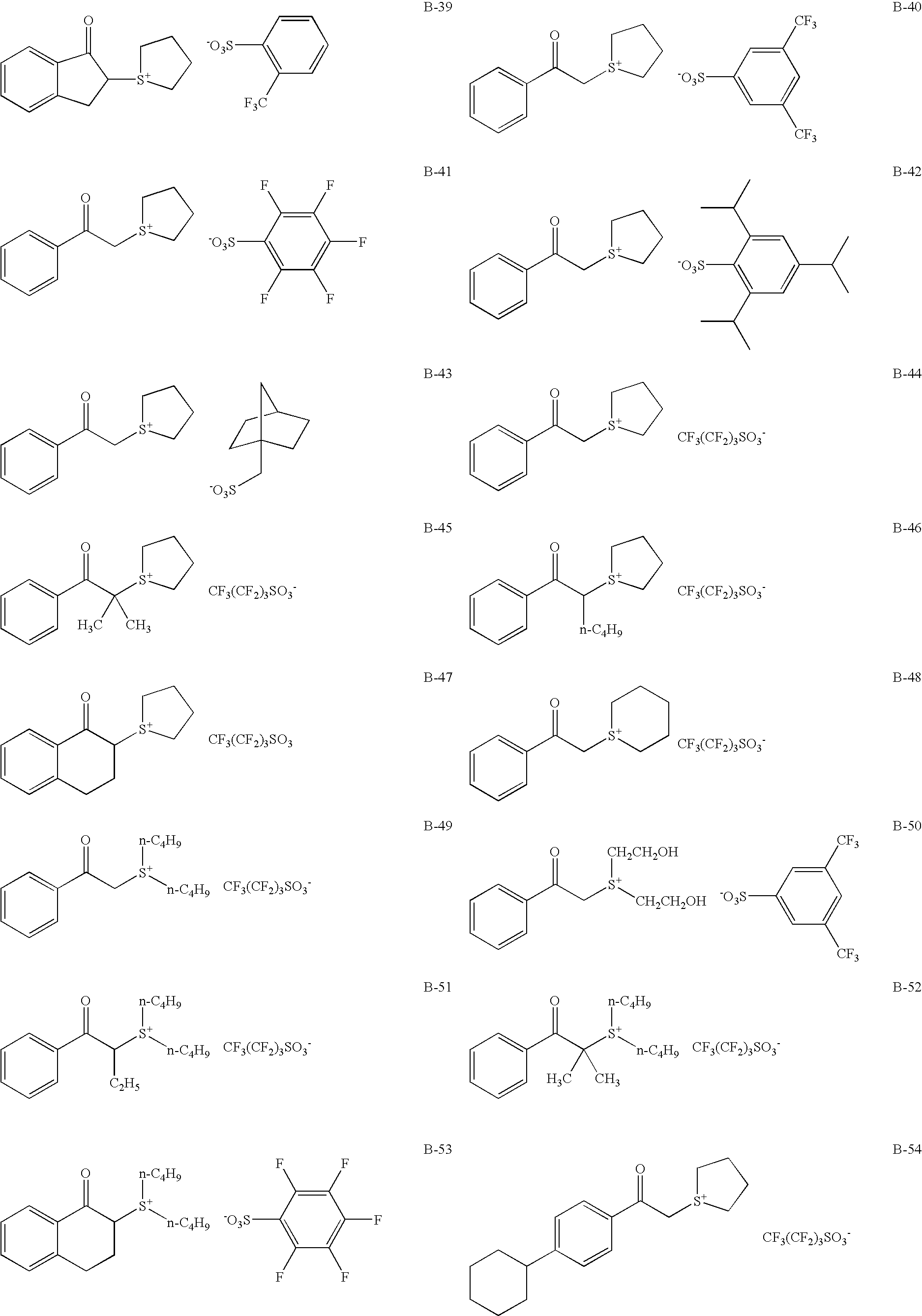

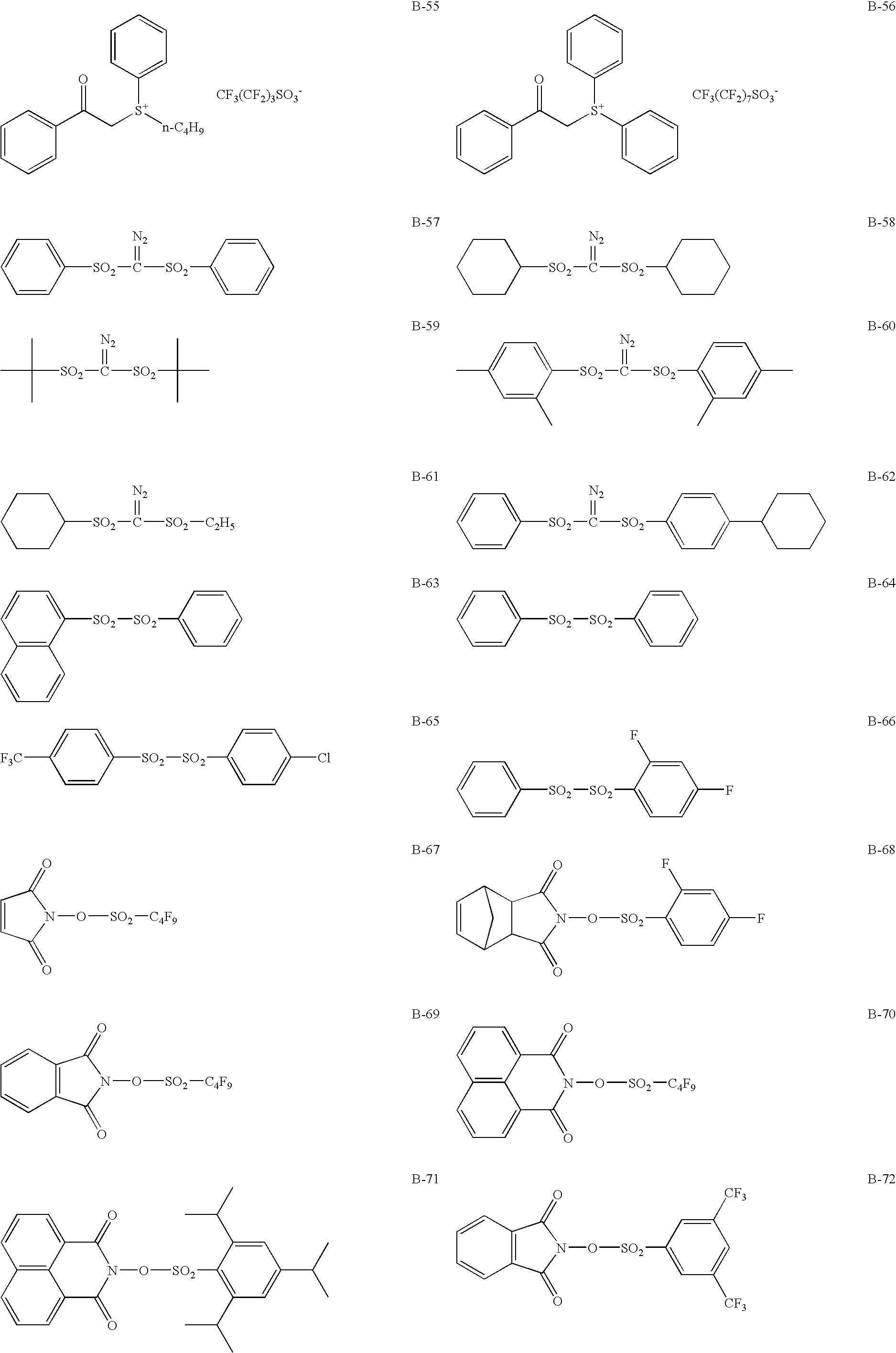

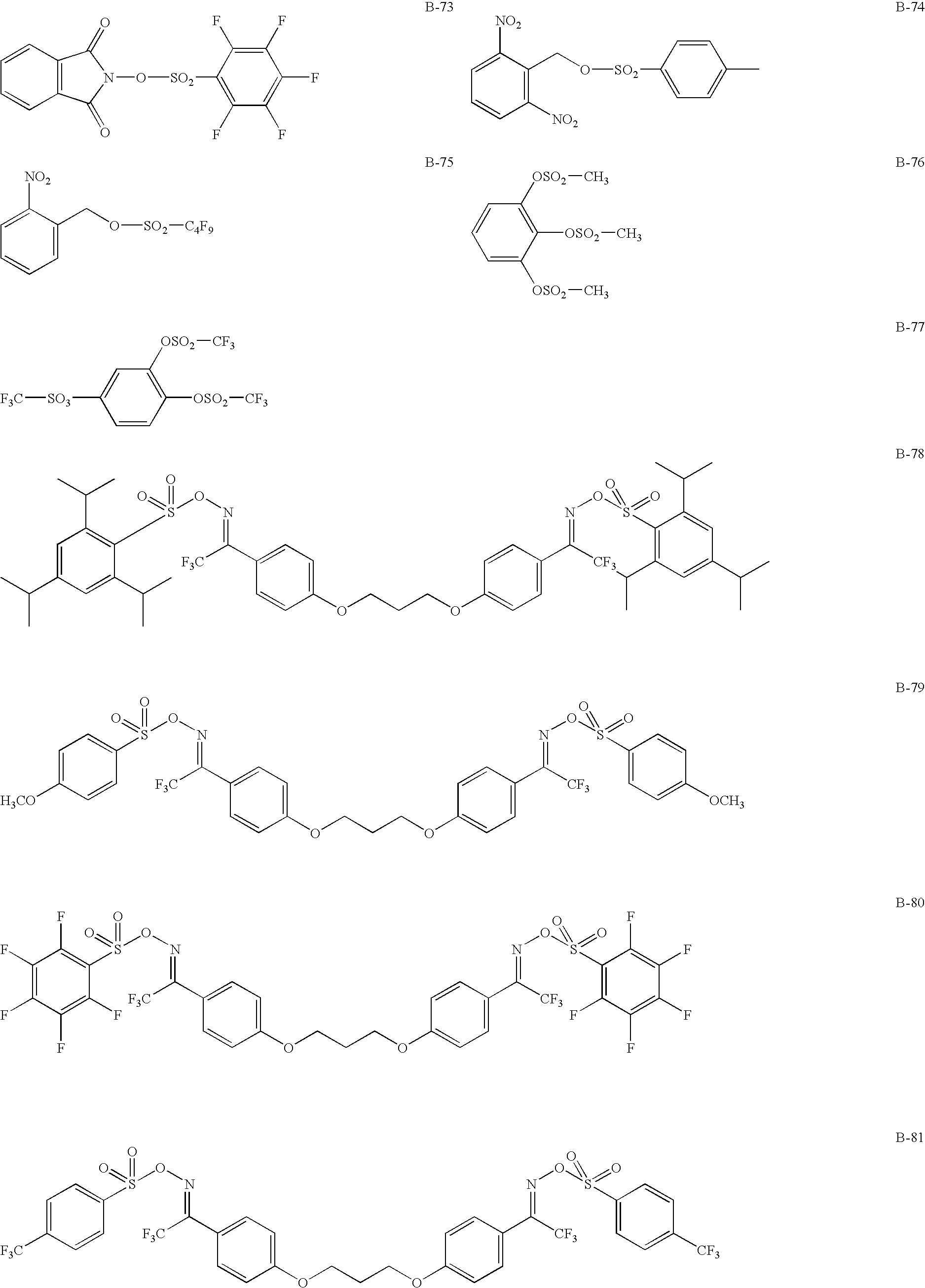

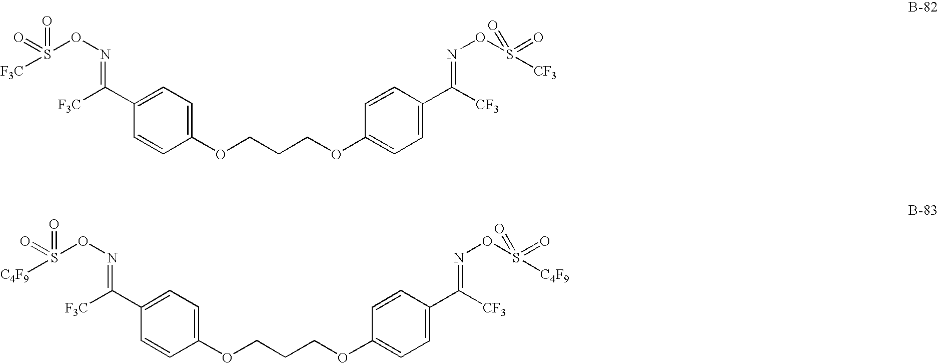

The content of compound (B) is from 5 to 20 mass % based on all the solids content of the resist composition, preferably from 6 to 18 mass %, and especially preferably from 7 to 16 mass %. The content is 5 mass % or more from the points of sensitivity and line edge roughness, and 20 mass % or less in the light of resolution, pattern form and film quality. Compound (B) may be used one kind alone, or two or more compounds may be used as admixture. For example, a compound capable of generating an arylsulfonic acid upon irradiation with an actinic ray or radiation and a compound capable of generating an alkylsulfonic acid may be used in combination as compound (B).

Compound (B) can be synthesized according to known methods, e.g., the synthesis method disclosed in JP-A-2002-27806.

Compound (C) Capable of Generating a Carboxylic Acid Upon Irradiation with an Actinic Ray or Radiation:

A compound capable of generating a carboxylic acid upon irradiation with an actinic ray or radiation (referred to as compound (C) or a carboxylic acid generator) may be used in the resist composition in the invention.

As the carboxylic acid generator, a compound represented by the following formula (C) is preferred.

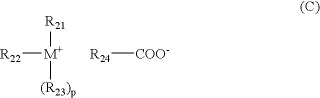

In formula (C), R₂₁, R₂₂ and R₂₃ each represents an alkyl group, a cycloalkyl group, an alkenyl group or an aryl group; R₂₄ represents a hydrogen atom, an alkyl group, a cycloalkyl group, an alkenyl group or an aryl group; M represents a sulfur atom or an iodine atom, when M represents a sulfur atom, p is 1, and when M represents an iodine atom, p is 0.

In formula (C), R₂₁, R₂₂ and R₂₃ each represents an alkyl group, a cycloalkyl group, an alkenyl group or an aryl group, and these groups may each have a substituent.

As the examples of the substituents that the alkyl group, cycloalkyl group, or alkenyl group may have, a halogen atom (e.g., a chlorine atom, a bromine atom, a fluorine atom, etc.), an aryl group (e.g., a phenyl group, a naphthyl group, etc.), a hydroxyl group, an alkoxyl group (e.g., a methoxy group, an ethoxy group, a butoxy group, etc.), etc., can be exemplified.

As the examples of the substituents that the aryl group may have, a halogen atom (e.g., a chlorine atom, a bromine atom, a fluorine atom, etc.), a nitro group, a cyano group, an alkyl group (e.g., a methyl group, an ethyl group, a t-butyl group, a t-amyl group, an octyl group, etc.), a hydroxyl group, an alkoxyl group (e.g., a methoxy group, an ethoxy group, a butoxy group, etc.), etc., can be exemplified.

R₂₁, R₂₂ and R₂₃ each preferably represents an alkyl group having from 1 to 12 carbon atoms, a cycloalkyl group having from 3 to 12 carbon atoms, an alkenyl group having from 2 to 12 carbon atoms, or an aryl group having from 6 to 24 carbon atoms, more preferably an alkyl group having from 1 to 6 carbon atoms, a cycloalkyl group having from 3 to 6 carbon atoms, or an aryl group having from 6 to 18 carbon atoms, and especially preferably an aryl group having from 6 to 15 carbon atoms. These groups may each have a substituent.

R₂₄ represents a hydrogen atom, an alkyl group, a cycloalkyl group, an alkenyl group, or an aryl group.

As the examples of the substituents that the alkyl group, cycloalkyl group, or alkenyl group may have, the same groups as described above as the examples of the substituents at the time when R₂₁ represents an alkyl group are exemplified. As the examples of the substituents of the aryl group, the same groups as described above as the examples of the substituents at the time when R₂₁ represents an aryl group are exemplified.

R₂₄ preferably represents a hydrogen atom, an alkyl group having from 1 to 30 carbon atoms, a cycloalkyl group having from 3 to 30 carbon atoms, an alkenyl group having from 2 to 30 carbon atoms, or an aryl group having from 6 to 24 carbon atoms, more preferably an alkyl group having from 1 to 18 carbon atoms, a cycloalkyl group having from 3 to 18 carbon atoms, or an aryl group having from 6 to 18 carbon atoms, and especially preferably an alkyl group having from 1 to 12 carbon atoms, a cycloalkyl group having from 3 to 12 carbon atoms, or an aryl group having from 6 to 15 carbon atoms. These groups may each have a substituent.

M represents a sulfur atom or an iodine atom. p is 1 when M represents a sulfur atom, and is 0 when M represents an iodine atom.

Incidentally, two or more cationic portions of formula (C) may be bonded via a single bond or a linking group (e.g., —S—, —O—, etc.) to form a cationic structure having a plurality of cationic portions of formula (C).

The preferred specific examples of compounds (C) capable of generating a carboxylic acid upon irradiation with an actinic ray or radiation are shown below, but the invention is by no means restricted thereto.

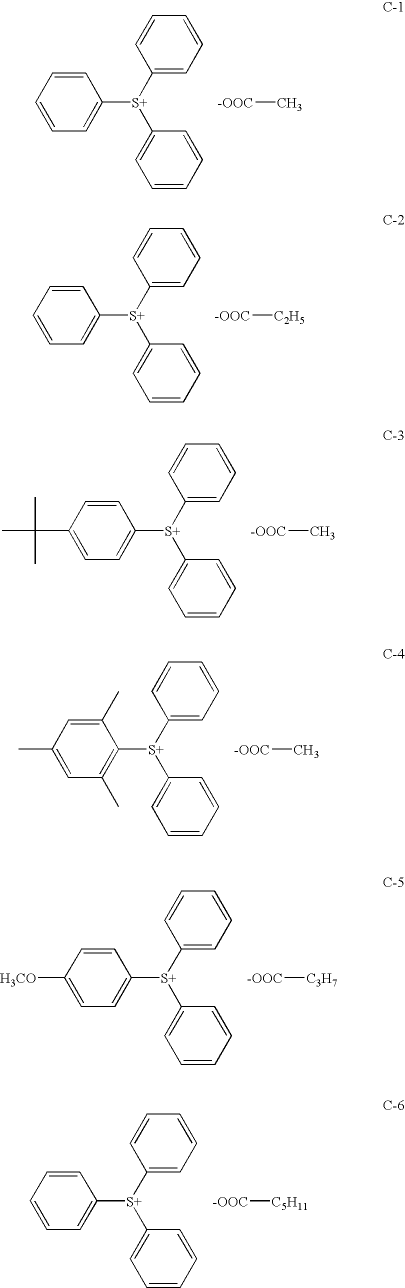

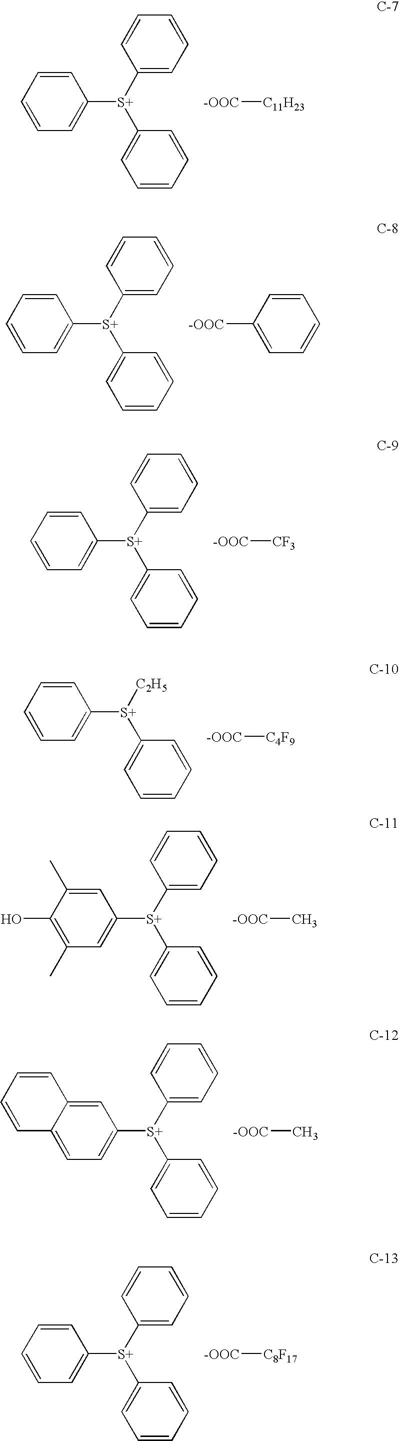

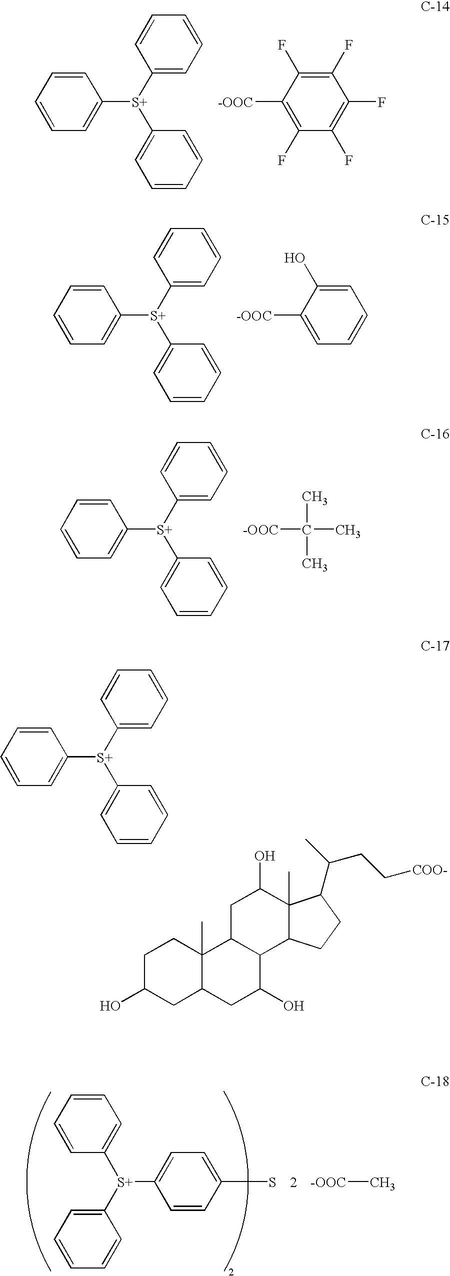

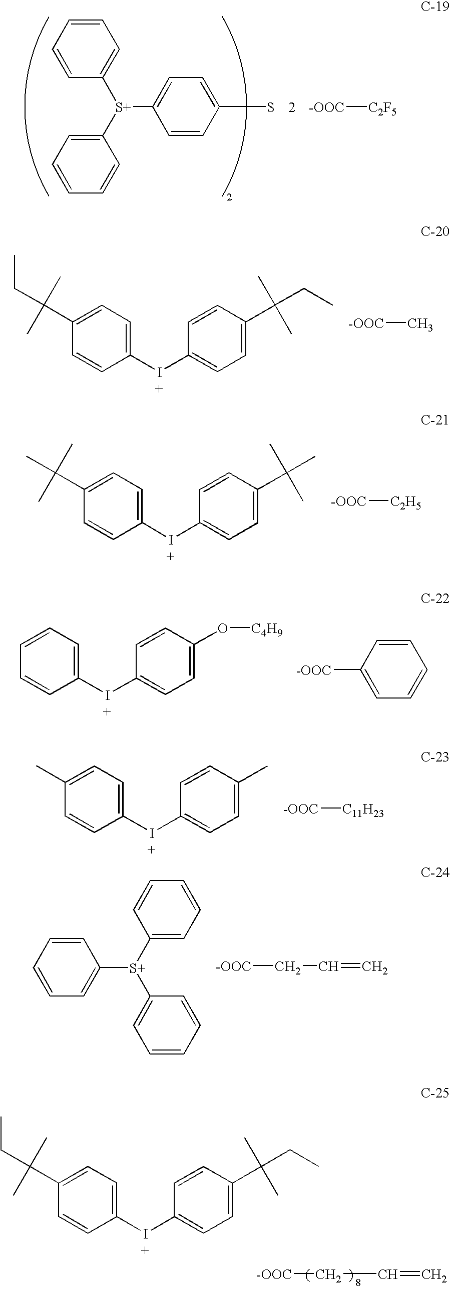

The content of compound (C) in the resist composition in the invention is preferably from 0.01 to 10 mass % based on all the solids content of the composition, more preferably from 0.03 to 5 mass %, and especially preferably from 0.05 to 3 mass %. These compounds capable of generating a carboxylic acid upon irradiation with an actinic ray or radiation may be used one kind alone, or two or more compounds may be used as admixture. Compound (C) can be synthesized according to known methods, e.g., the synthesis method disclosed in JP-A-2002-27806.

In the invention, a sulfonic acid generator (compound (B)) is preferred, and further, it is preferred to use a sulfonic acid generator (compound (B)) and a carboxylic acid generator (compound (C)) in combination.

Compound (C)/compound (B) (by mass) is generally from 99.9/0.1 to 50/50, preferably from 99/1 to 60/40, and especially preferably from 98/2 to 70/30.

[3] Organic Basic Compound:

From the aspect of the improvement of performances such as resolution and preservation stability, it is preferred to use an organic basic compound in the invention. As the organic basic compound, a compound containing a nitrogen atom (a nitrogen-containing basic compound) is more preferred.

The preferred organic basic compound in the invention is a compound stronger in basicity than phenol.

As preferred chemical environment, the following structures (A) to (E) can be exemplified. Formulae (B) to (E) may be a part of a cyclic structure.

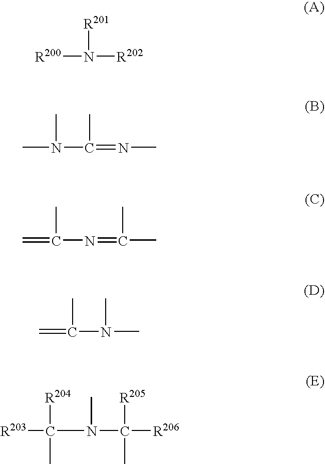

In formula (A), R²⁰⁰, R²⁰¹ and R²⁰², which may be the same or different, each represents a hydrogen atom, an alkyl group (preferably having from 1 to 20 carbon atoms), a cycloalkyl group (preferably having from 3 to 20 carbon atoms), or an aryl group (preferably having from 6 to 20 carbon atoms), and R²⁰¹ and R²⁰² may be bonded to each other to form a ring.

The alkyl group, cycloalkyl group and aryl group represented by R²⁰⁰, R²⁰¹ and R²⁰² may each have a substituent. As the alkyl group and cycloalkyl group having a substituent, an aminoalkyl group having from 1 to 20 carbon atoms, an aminocycloalkyl group having from 1 to 20 carbon atoms, and a hydroxyalkyl group having from 1 to 20 carbon atoms are preferred.

In formula (E), R²⁰³, R²⁰⁴, R²⁰⁵ and R²⁰⁶, which may be the same or different, each represents an alkyl group having from 1 to 6 carbon atoms, or a cycloalkyl group having from 1 to 6 carbon atoms.

More preferred organic basic compounds are nitrogen-containing basic compounds having two or more nitrogen atoms of different chemical environments in one molecule, and especially preferred compounds are compounds containing both of a substituted or unsubstituted amino group and a cyclic structure containing a nitrogen atom, or compounds having an alkylamino group.

Further, at least one nitrogen-containing compound selected from an amine compound having a phenoxy group, an ammonium salt compound having a phenoxy group, an amine compound having a sulfonic ester group, and an ammonium salt compound having a sulfonic ester group can be exemplified.

As the amine compound, a primary, secondary, or tertiary amine compound can be used, and an amine compound having at least one alkyl group bonded to a nitrogen atom is preferred. The amine compound is more preferably a tertiary amine compound. In the amine compound, if at least one alkyl group (preferably having from 1 to 20 carbon atoms) is bonded to a nitrogen atom, besides the alkyl group, a cycloalkyl group (preferably having from 3 to 20 carbon atoms) or an aryl group (preferably having from 6 to 12 carbon atoms) may be bonded to a nitrogen atom. It is preferred for the amine compound to have an oxygen atom in the alkyl chain to form an oxyalkylene group. The number of the oxyalkylene group is 1 or more in the molecule, preferably from 3 to 9, and more preferably from 4 to 6. Of the oxyalkylene groups, an oxyethylene group (—CH₂CH₂O), or an oxypropylene group (—CH(CH₃)CH₂O— or —CH₂CH₂CH₂O—) is preferred, and an oxyethylene group is more preferred.

As the ammonium salt compound, a primary, secondary, tertiary or quaternary ammonium salt compound can be used, and an ammonium salt compound having at least one alkyl group bonded to a nitrogen atom is preferred. In the ammonium salt compound, if at least one alkyl group (preferably having from 1 to 20 carbon atoms) is bonded to a nitrogen atom, besides the alkyl group, a cycloalkyl group (preferably having from 3 to 20 carbon atoms) or an aryl group (preferably having from 6 to 12 carbon atoms) may be bonded to a nitrogen atom. It is preferred for the ammonium salt compound to have an oxygen atom in the alkyl chain to form an oxyalkylene group. The number of the oxyalkylene group is 1 or more in the molecule, preferably from 3 to 9, and more preferably from 4 to 6. Of the oxyalkylene groups, an oxyethylene group (—CH₂CH₂O), or an oxypropylene group (—CH(CH₃)CH₂O— or —CH₂CH₂CH₂O—) is preferred, and an oxyethylene group is more preferred. As the anion of the ammonium salt group, a halogen atom, sulfonate, borate, phosphate, etc., are exemplified, and a halogen atom and sulfonate are preferred of these. As the halogen atom, chlorine, bromine and iodine are especially preferred, and as the sulfonate, organic sulfonate having from 1 to 20 carbon atoms is especially preferred. As the organic sulfonate, alkylsulfonate having from 1 to 20 carbon atoms, and arylsulfonate are exemplified. The alkyl group of the alkylsulfonate may have a substituent, and as the examples of the substituents, e.g., fluorine, chlorine, bromine, an alkoxyl group, an acyl group and an aryl group are exemplified. As the specific examples of the alkylsulfonate, methane-sulfonate, ethanesulfonate, butanesulfonate, hexanesulfonate, octanesulfonate, benzylsulfonate, trifluoromethanesulfonate, pentafluoroethanesulfonate, nonafluorobutanesulfonate, etc., are exemplified. As the aryl group of the arylsulfonate, a benzene ring, a naphthalene ring and an anthracene ring are exemplified. These benzene ring, naphthalene ring and anthracene ring may each have a substituent, and as the substituent, a straight chain or branched alkyl group having from 1 to 6 carbon atoms, and a cycloalkyl group having from 3 to 6 carbon atoms are preferred. As the straight chain or branched alkyl group and cycloalkyl group, methyl, ethyl, n-propyl, isopropyl, n-butyl, i-butyl, t-butyl, n-hexyl, cyclohexyl, etc., are specifically exemplified. As other substituents, an alkoxyl group having from 1 to 6 carbon atoms, a halogen atom, a cyano group, a nitro group, an acyl group, an acyloxy group, etc., are exemplified.

The amine compound having a phenoxy group and the ammonium salt compound having a phenoxy group are compounds having a phenoxy group on the terminal on the opposite side to the nitrogen atoms of the alkyl groups of the amine compound and ammonium salt compound. The phenoxy group may have a substituent. As the substituents of the phenoxy group, e.g., an alkyl group, an alkoxyl group, a halogen atom, a cyano group, a nitro group, a carboxyl group, a carboxylic ester group, a sulfonic ester group, an aryl group, an aralkyl group, an acyloxy group, an aryloxy group and the like are exemplified. The substitution position of the substituent may be any of from 2 to 6-positions, and the number of substituents may be any in the range of from 1 to 5.

It is preferred to have at least one oxyalkylene group between the phenoxy group and nitrogen atom. The number of oxyalkylene group is 1 or more in the molecule, preferably from 3 to 9, and more preferably from 4 to 6. Of the oxyalkylene groups, an oxyethylene group (—CH₂CH₂O), or an oxypropylene group (—CH(CH₃)CH₂O— or —CH₂CH₂CH₂O—) is preferred, and an oxyethylene group is more preferred.

Incidentally, the amine compound having a phenoxy group can be obtained as follows: a primary or secondary amine having a phenoxy group is reacted with haloalkyl ether by heating, and then an aqueous solution of a strong base such as sodium hydroxide, potassium hydroxide, tetraalkylammonium, or the like is added to the above reaction solution, and an amine compound is extracted with an organic solvent such as ethyl acetate, chloroform, or the like. Alternatively, a primary or secondary amine is reacted with haloalkyl ether having a phenoxy group on the terminal by heating, and then an aqueous solution of a strong base such as sodium hydroxide, potassium hydroxide, tetraalkylammonium, or the like is added to the above reaction solution, and an amine compound is extracted with an organic solvent such as ethyl acetate, chloroform, or the like.

The sulfonic ester group in the amine compound having a sulfonic ester group and the ammonium salt compound having a sulfonic ester group may be any of alkylsulfonic ester, cycloalkylsulfonic ester, and arylsulfonic ester. In the case of alkylsulfonic ester, the number of carbon atom of the alkyl group is preferably from 1 to 20, in the case of cycloalkyl-sulfonic ester, the number of carbon atom of the cycloalkyl group is preferably from 3 to 20, and in the case of arylsulfonic ester, the number of carbon atom of the aryl group is preferably from 6 to 12. These alkylsulfonic ester, cycloalkylsulfonic ester and arylsulfonic ester may each have a substituent, and the examples of preferred substituents include a halogen atom, a cyano group, a nitro group, a carboxyl group, a carboxylic ester group, and a sulfonic ester group.

It is preferred to have at least one oxyalkylene group between the sulfonic ester group and nitrogen atom. The number of oxyalkylene group is 1 or more in the molecule, preferably from 3 to 9, and more preferably from 4 to 6. Of the oxyalkylene groups, an oxyethylene group (—CH₂CH₂O), or an oxypropylene group (—CH(CH₃)CH₂O— or —CH₂CH₂CH₂O—) is preferred, and an oxyethylene group is more preferred.

As preferred organic basic compounds, guanidine, aminopyridine, aminoalkylpyridine, aminopyrrolidine, indazole, imidazole, pyrazole, pyrazine, pyrimidine, purine, imidazoline, pyrazoline, piperazine, aminomorpholine, aminoalkylmorpholine, etc., are exemplified. These organic basic compounds may each have a substituent, and as preferred substituents, an amino group, an aminoalkyl group, an alkylamino group, an aminoaryl group, an arylamino group, an alkyl group, an alkoxyl group, an acyl group, an acyloxy group, an aryl group, an aryloxy group, a nitro group, a hydroxyl group, a cyano group, etc., are exemplified.

As especially preferred organic basic compounds, guanidine, 1,1-dimethylguanidine, 1,1,3,3-tetramethyl-guanidine, imidazole, 2-methylimidazole, 4-methylimidazole, N-methylimidazole, 2-phenylimidazole, 4,5-diphenylimidazole, 2,4,5-triphenylimidazole, 2-aminopyridine, 3-aminopyridine, 4-aminopyridine, 2-dimethylaminopyridine, 4-dimethylamino-pyridine, 2-diethylaminopyridine, 2-(aminomethyl)pyridine, 2-amino-3-methylpyridine, 2-amino-4-methylpyridine, 2-amino-5-methylpyridine, 2-amino-6-methylpyridine, 3-aminoethylpyridine, 4-aminoethylpyridine, 3-amino-pyrrolidine, piperazine, N-(2-aminoethyl)piperazine, N-(2-aminoethyl)piperidine, 4-amino-2,2,6,6-tetramethyl-piperidine, 4-piperidinopiperidine, 2-iminopiperidine, 1-(2-aminoethyl)pyrrolidine, pyrazole, 3-amino-5-methyl-pyrazole, 5-amino-3-methyl-1-p-tolylpyrazole, pyrazine, 2-(aminomethyl)-5-methylpyrazine, pyrimidine, 2,4-diamino-pyrimidine, 4,6-dihydroxypyrimidine, 2-pyrazoline, 3-pyrazoline, N-aminomorpholine, N-(2-aminoethyl)morpholine, etc., are exemplified, but the invention is not restricted to these compounds.

Tetraalkylammonium salt type nitrogen-containing basic compounds can also be used. As such compounds, tetraalkyl-ammonium hydroxide (e.g., tetramethylammonium hydroxide, tetraethylammonium hydroxide, tetra(n-butyl)ammonium hydroxide, etc.) having from 1 to 8 carbon atoms are especially preferred. These nitrogen-containing basic compounds are used alone, or two or more compounds are used in combination.

As preferred specific examples of nitrogen-containing basic compounds, guanidine, aminopyridine, aminoalkylpyridine, aminopyrrolidine, indazole, imidazole, pyrazole, pyrazine, pyrimidine, purine, imidazoline, pyrazoline, piperazine, aminomorpholine, aminoalkylmorpholine, etc., are exemplified. As preferred substituents that these compounds may have, an amino group, an alkylamino group, an aminoaryl group, an arylamino group, an alkyl group (as a substituted alkyl group, especially an aminoalkyl group), an alkoxyl group, an acyl group, an acyloxy group, an aryl group, an aryloxy group, a nitro group, a hydroxyl group, a cyano group, etc., are exemplified.

As especially preferred compounds, guanidine, 1,1-dimethylguanidine, 1,1,3,3-tetramethylguanidine, imidazole, 2-methylimidazole, 4-methylimidazole, N-methylimidazole, 2-phenylimidazole, 4,5-diphenylimidazole, 2,4,5-triphenylimidazole, 2-aminopyridine, 3-aminopyridine, 4-aminopyridine, 2-dimethylaminopyridine, 4-dimethylaminopyridine, 2-diethylaminopyridine, 2-(aminomethyl)pyridine, 2-amino-3-methylpyridine, 2-amino-4-methylpyridine, 2-amino-5-methylpyridine, 2-amino-6-methylpyridine, 3-amino ethylpyridine, 4-amino ethylpyridine, 3-aminopyrrolidine, piperazine, N-(2-aminoethyl)piperazine, N-(2-aminoethyl)piperidine, 4-amino-2,2,6,6-tetramethylpiperidine, 4-piperidinopiperidine, 2-iminopiperidine, 1-(2-aminoethyl)pyrrolidine, pyrazole, 3-amino-5-methylpyrazole, 5-amino-3-methyl-1-p-tolylpyrazole, pyrazine, 2-(aminomethyl)-5-methylpyrazine, pyrimidine, 2,4-diaminopyrimidine, 4,6-dihydroxypyrimidine, 2-pyrazoline, 3-pyrazoline, N-aminomorpholine, N-(2-aminoethyl)morpholine, etc., are exemplified, but the invention is not restricted thereto.

These nitrogen-containing basic compounds are used alone, or two or more kinds in combination.

Tetraalkylammonium salt type nitrogen-containing basic compounds can also be used. As such compounds, tetraalkylammonium hydroxide (e.g., tetramethylammonium hydroxide, tetraethylammonium hydroxide, tetra(n-butyl)ammonium hydroxide, etc.) having from 1 to 8 carbon atoms are especially preferred. These nitrogen-containing basic compounds are used alone, or two or more compounds are used in combination.

The use proportion of an acid generator and an organic basic compound in a composition is preferably (the total amount of acid generators)/(an organic basic compound) of from 2.5 to 300 in a molar ratio. By making the molar ratio 2.5 or more, sensitivity can be increased, and by making 300 or less, thickening of a resist pattern by aging after exposure until heating treatment can be restrained and resolution can be improved. (Total amount of acid generators)/(an organic basic compound) (molar ratio) is more preferably from 5.0 to 200, and still more preferably from 7.0 to 150.

[4] Surfactants:

Surfactants can be used in the invention. To use surfactants is preferred from the point of view of film forming property, adhesion property of a pattern, and the decrease in development defects.

The specific examples of surfactants include nonionic surfactants, such as polyoxyethylene alkyl ethers, e.g., polyoxyethylene lauryl ether, polyoxyethylene stearyl ether, polyoxyethylene cetyl ether, polyoxyethylene oleyl ether, etc., polyoxyethylene alkylallyl ethers, e.g., polyoxyethylene octylphenol ether, polyoxyethylene nonylphenol ether, etc., polyoxyethylene-polyoxypropylene block copolymers, sorbitan fatty acid esters, e.g., sorbitan monolaurate, sorbitan monopalmitate, sorbitan monostearate, sorbitan monooleate, sorbitan trioleate, sorbitan tristearate, etc., and polyoxyethylene sorbitan fatty acid esters, e.g., polyoxyethylene sorbitan monolaurate, polyoxyethylene sorbitan monopalmitate, polyoxyethylene sorbitan monostearate, polyoxyethylene sorbitan trioleate, polyoxyethylene sorbitan tristearate, etc.; fluorine surfactants and silicon surfactants such as Eftop EF301, EF303, and EF352 (manufactured by Shin-Akita Kasei Co., Ltd.), Megafac F171 and F173 (manufactured by Dainippon Ink and Chemicals Inc.), Fluorad FC430 and FC431 (manufactured by Sumitomo 3M Limited), Asahi Guard AG710, Sarfron S-382, SC101, SC102, SC103, SC104, SC105, and SC106 (manufactured by Asahi Glass CO., LTD.), and Troy Sol S-366 (manufactured by Troy Chemical Co., Ltd.); and organosiloxane polymer KP341 (manufactured by Shin-Etsu Chemical Co., Ltd.), and acrylic or methacrylic (co)polymer POLYFLOW No. 75 and No. 95 (manufactured by Kyoei Chemical Co., Ltd.). The blending amount of these surfactants is generally 2 mass parts or lower per 100 mass parts of the solids content of the composition of the invention, and preferably 1 mass part or lower.

These surfactants may be used one kind alone, or a plurality of surfactants may be used in combination.

Incidentally, it is preferred to use either one or two or more of fluorine and/or silicon surfactants (a fluorine surfactant, a silicon surfactant, a surfactant containing both a fluorine atom and a silicon atom).

As these surfactants, the surfactants disclosed, e.g., in the specifications of the following patents can be used: JP-A-62-36663, JP-A-61-226746, JP-A-61-226745, JP-A-62-170950, JP-A-63-34540, JP-A-7-230165, JP-A-8-62834, JP-A-9-54432, JP-A-9-5988, JP-A-2002-277862, U.S. Pat. Nos. 5,405,720, 5,360,692, 5,529,881, 5,296,330, 5,436,098, 5,576,143, 5,294,511 and 5,824,451. Commercially available surfactants shown below can also be used as they are.

As commercially available surfactants usable in the invention, fluorine or silicon surfactants such as Eftop EF301 and EF303 (manufactured by Shin-Akita Kasei Co., Ltd.), Fluorad FC 430 and 431 (manufactured by Sumitomo 3M Limited), Megafac F171, F173, F176, F189 and R08 (manufactured by Dainippon Ink and Chemicals Inc.), Sarfron S-382, SC101, 102, 103, 104, 105 and 106 (manufactured by Asahi Glass CO., LTD.), and Troy Sol S-366 (manufactured by Troy Chemical Co., Ltd.) are exemplified. In addition, polysiloxane polymer KP-341 (manufactured by Shin-Etsu Chemical Co., Ltd.) can also be used as a silicon surfactant.

As surfactants, in addition to the above-shown well-known surfactants, surfactants using polymers having a fluoro-aliphatic group derived from a fluoro-aliphatic compound manufactured by a telomerization method (also called a telomer method) or an oligomerization method (also called an oligomer method) can be used. The fluoro-aliphatic compound can be synthesized according to the method disclosed in JP-A-2002-90991.

As the polymers having a fluoro-aliphatic group, copolymers of monomers having a fluoro-aliphatic group and (poly(oxyalkylene)) acrylate and/or (poly(oxyalkylene)) methacrylate are preferred, and these copolymers may be irregularly distributed or may be block copolymerized. As the poly(oxyalkylene) groups, a poly(oxyethylene) group, a poly(oxypropylene) group, and a poly(oxybutylene) group are exemplified. Further, the polymers may be units having alkylene different in a chain length in the same chain length, such as a poly(oxyethylene and oxypropylene and oxyethylene block combination) group, and a poly(oxyethylene and oxypropylene block combination) group. In addition, copolymers of monomers having fluoro-aliphatic groups and poly(oxyalkylene) acrylate (or methacrylate) may be not only bipolymers but also terpolymers or higher polymers obtained by copolymerization of monomers having different two or more kinds of fluoro-aliphatic groups, or different two or more kinds of poly(oxyalkylene) acrylates (or methacrylates) at the same time.

For example, as commercially available surfactants, Megafac F178, F470, F473, F475, F476 and F472 (manufactured by Dainippon Ink and Chemicals Inc.) can be exemplified. Further, copolymers of acrylate (or methacrylate) having a C₆F₁₃ group and (poly(oxyalkylene)) acrylate (or methacrylate), copolymers of acrylate (or methacrylate) having a C₆F₁₃ group, (poly(oxyethylene)) acrylate (or methacrylate), and (poly(oxypropylene)) acrylate (or methacrylate), copolymers of acrylate (or methacrylate) having a C₈F₁₇ group and (poly(oxyethylene)) acrylate (or methacrylate), copolymers of acrylate (or methacrylate) having a C₈F₁₇ group, (poly(oxyethylene)) acrylate (or methacrylate), and (poly(oxypropylene)) acrylate (or methacrylate), etc., are exemplified.

The use amount of surfactants is preferably from 0.0001 to 2 mass % based on all the amount of the resist composition (excluding solvents), and more preferably from 0.001 to 1 mass %.

[5] Other Components:

The resist composition in the invention can further contain a dye and a photo-base generator, if necessary.

1. Dyes:

A dye can be used in the invention.

As preferred dyes, oil dyes and basic dyes are exemplified. Specifically, Oil Yellow #101, Oil Yellow #103, Oil Pink #312, Oil Green BG, Oil Blue BOS, Oil Blue #603, Oil Black BY, Oil Black BS, Oil Black T-505 (products of Orient Chemical Industries, Ltd.), Crystal Violet (C.I. 42555), Methyl Violet (C.I. 42535), Rhodamine B (C.I. 45170B), Malachite Green (C.I. 42000), Methylene Blue (C.I. 52015), etc., can be exemplified.

2. Photo-Base Generators:

As photo-base generators that can be added to the composition of the invention, the compounds disclosed in JP-A-4-151156, JP-A-4-162040, JP-A-5-197148, JP-A-5-5995, JP-A-6-194834, JP-A-8-146608, JP-A-10-83079, and EP 622682 can be exemplified. Specifically, 2-nitrobenzyl carbamate, 2,5-dinitrobenzyl cyclohexylcarbamate, N-cyclohexyl-4-methylphenylsulfonamide, 1,1-dimethyl-2-phenylethyl-N-isopropyl carbamate, etc., can be preferably used. These photo-base generators are added for the purpose of the improvement of resist form and the like.

3. Solvents:

The above components of the resist composition in the invention are dissolved in a solvent and coated on a support. The concentration of the solids content of all the resist composition is generally preferably from 2 to 30 mass %, and more preferably from 3 to 25 mass %.

As the solvents used here, ethylene dichloride, cyclohexanone, cyclopentanone, 2-heptanone, γ-butyrolactone, methyl ethyl ketone, ethylene glycol monomethyl ether, ethylene glycol monoethyl ether, 2-methoxyethyl acetate, ethylene glycol monoethyl ether acetate, propylene glycol monomethyl ether, propylene glycol monomethyl ether acetate, toluene, ethyl acetate, methyl lactate, ethyl lactate, methyl methoxypropionate, ethyl ethoxypropionate, methyl pyruvate, ethyl pyruvate, propyl pyruvate, N,N-dimethylformamide, dimethyl sulfoxide, N-methylpyrrolidone, tetrahydrofuran, etc., are preferred, and these solvents are used alone or as admixture.

The positive resist composition in the invention is coated on a substrate to form a thin film. The thickness of the coated film is preferably from 0.05 to 4.0 μm.

In the invention, if necessary, commercially available inorganic or organic antireflection films can be used. It is also possible to coat an antireflection film as the lower layer of the resist.

As antireflection films used as the lower layer of the resist, both of an inorganic film type, e.g., titanium, titanium dioxide, titanium nitride, chromium oxide, carbon, amorphous silicon, etc., and an organic film type, e.g., films comprising light absorbers and polymer materials can be used. The former necessitates equipments such as a vacuum evaporation apparatus, a CVD apparatus, or a sputtering apparatus in film forming. As organic antireflection films, e.g., those comprising condensation products of diphenylamine derivatives and formaldehyde-modified melamine resins, alkali-soluble resins and light absorbers as disclosed in JP-B-7-69611 (the term “JP-B” as used herein refers to an “examined Japanese patent publication”), reaction products of maleic anhydride copolymers and diamine-type light absorbers as disclosed in U.S. Pat. No. 5,294,680, antireflection films containing resin binders and methylolmelamine series thermal crosslinking agents as disclosed in JP-A-6-118631, acrylic resin type antireflection films having a carboxylic acid group, an epoxy group and a light-absorbing group in the same molecule as disclosed in JP-A-6-118656, antireflection films comprising methylolmelamine and benzophenone series light absorbers as disclosed in JP-A-8-87115, and antireflection films obtained by adding low molecular weight light absorbers to polyvinyl alcohol resins as disclosed in JP-A-8-179509 are exemplified.

As organic antireflection films, commercially available products such as DUV-30 series and DUV-40 series manufactured by Brewer Science, and AR-2, AR-3 and AR-5 manufactured by Shipley Co. can also be used.

In a pattern forming process on a resist film in the manufacture of precision integrated circuit elements, the positive resist composition of the invention is coated on a substrate (e.g., a silicon/silicon dioxide coated substrate, a glass substrate, an ITO substrate, a quartz/chromium oxide coated substrate, etc.) to form a resist film, and the resist film is subjected to irradiation with actinic ray or radiation such as KrF excimer laser beams, electron beams, EUV rays, etc., heating, development, rinsing, and drying, whereby a good resist pattern can be formed.

As alkali developing solutions for use in the development process, alkali aqueous solutions (generally from 0.1 to 20 mass %) of inorganic alkalis, e.g., sodium hydroxide, potassium hydroxide, sodium carbonate, sodium silicate, sodium metasilicate, aqueous ammonia, etc., primary amines, e.g., ethylamine, n-propylamine, etc., secondary amines, e.g., diethylamine, di-n-butylamine, etc., tertiary amines, e.g., triethylamine, methyldiethylamine, etc., alcohol amines, e.g., dimethylethanolamine, triethanolamine, etc., quaternary ammonium salts, e.g., tetramethylammonium hydroxide, tetraethylammonium hydroxide, choline, etc., and cyclic amines, e.g., pyrrole, piperidine, etc., can be used. An appropriate amount of alcohols, e.g., isopropyl alcohol, etc., and nonionic surfactants may be added to the aqueous solutions of alkalis.

Of these developing solutions, quaternary ammonium salts are preferred, and tetramethylammonium hydroxide and choline are more preferred.

The pH of the alkali developing solution is generally from 10 to 15.

### EXAMPLE

The invention will be described in further detail with reference to examples, but the invention is not restricted thereto.

### Synthesis Example 1

### Synthesis of Specific Example A-1 of Resin (A)

Acetoxystyrene and 1-phenylethyl methacrylate in proportion of 90/10 (molar ratio) are dissolved in tetrahydrofuran to prepare 100 ml of a solution having concentration of solids content of 20 mass %. Polymerization initiator V-65 (manufactured by Wako Pure Chemical Industries) (2 mol %) is added to the solution, and the mixture is dripped into 10 ml of tetrahydrofuran heated at 60° C. over 4 hours in nitrogen atmosphere. After termination of dripping, the reaction solution is heated for 4 hours, 1 mol % of V-65 is added again, and the reaction solution is stirred for 4 hours. After termination of the reaction, the reaction solution is cooled to room temperature and crystallized with 3 liters of hexane, and precipitated white powder is collected by filtration.

The composition ratio of the polymer is 89/11 (molar ratio) from C¹³NMR analysis. The weight average molecular weight of the polymer obtained by GPC measurement is 9,500 as standard polystyrene equivalent.

After the polymer is dissolved in 100 ml of THF, 10 ml of a 20% tetramethylammonium hydroxide aqueous solution is added thereto, and the reaction mixture is stirred for 4 hours, and then distilled water is added to precipitate the polymer. The precipitate is washed with distilled water, and dried under reduced pressure. After the polymer is dissolved in 100 ml of ethyl acetate, hexane is added and the precipitated polymer is dried under reduced pressure to obtain powder. The weight average molecular weight of the powder obtained by GPC measurement is 10,000 as standard polystyrene equivalent.

The obtained resin is dissolved in PGMEA, and 1 mol % of pyridium paratoluenesulfonate based on the polymer and 25 mol % of ethylene glycol divinyl ether are added to the solution, and the reaction mixture is reacted at room temperature for 4 hours. Triethylamine (10 mol %) is added to terminate the reaction, and the reaction solution is separated with pure water. Water is distilled off by azeotropy with PGMEA to thereby obtain a PGMEA solution of resin (A-1).

The composition ratio of the polymer is 69/11/20 (molar ratio) from C¹³NMR analysis. The weight average molecular weight of the polymer obtained by GPC measurement is 12,000 as standard polystyrene equivalent.

### Synthesis Example 1′

### Synthesis of Specific Example A-9 of Resin (A)

Acetoxystyrene, 1-phenylethyl methacrylate, and 1,4-(2-methacryloylethyl)benzene in proportion of 70/25/5 (molar ratio) are dissolved in tetrahydrofuran to prepare 100 ml of a solution having concentration of solids content of 20 mass %. Polymerization initiator V-65 (manufactured by Wako Pure Chemical Industries) (2 mol %) is added to the solution, and the mixture is dripped into 10 ml of tetrahydrofuran heated at 60° C. over 4 hours in nitrogen atmosphere. After termination of dripping, the reaction solution is heated for 4 hours, 1 mol % of V-65 is added again, and the reaction solution is stirred for 4 hours. After termination of the reaction, the reaction solution is cooled to room temperature and crystallized with 3 liters of hexane, and precipitated white powder is collected by filtration.

After the polymer is dissolved in 100 ml of THF, 10 ml of a 20% tetramethylammonium hydroxide aqueous solution is added thereto, and the reaction mixture is stirred for 4 hours, and then distilled water is added to precipitate the polymer. After the polymer is dissolved in 100 ml of ethyl acetate, hexane is added and the precipitated polymer is dried under reduced pressure to obtain powder. The composition ratio of the polymer is 73/23/4 (molar ratio) from C¹³NMR analysis. The weight average molecular weight of the polymer obtained by GPC measurement is 7,480 as standard polystyrene equivalent.

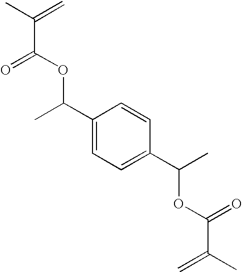

### 1,4-(2-Methacryloylethyl)benzene

The resins the structures of which are exemplified above are synthesized in the same manner as in the above synthesis examples. The molar ratio of repeating units, weight average molecular weight and polydispersity of each of the obtained resins are shown in Table 1 below.

TABLE 1

| | Repeating Unit | Weight Average | |
|---|---|---|---|
| Resin | (mol %) | Molecular Weight | Polydispersity |
| A-1 | 69/11/20 | 12,000 | 2.31 |
| A-2 | 70/24/6 | 10,500 | 2.29 |
| A-3 | 65/23/12 | 8,000 | 1.59 |
| A-4 | 67/30/3 | 9,000 | 1.75 |
| A-5 | 59/27/14 | 10,000 | 1.75 |
| A-6 | 81/13/6 | 9,500 | 1.82 |
| A-7 | 75/21/4 | 7,500 | 1.65 |
| A-8 | 68/26/6 | 8,900 | 1.52 |
| A-9 | 73/23/4 | 7,480 | 1.59 |
| A-10 | 78/14/8 | 7,600 | 1.75 |
| A-11 | 74/21/5 | 8,900 | 1.79 |
| A-12 | 69/21/10 | 9,600 | 1.63 |
| A-13 | 73/18/6/3 | 10,300 | 1.47 |
| A-14 | 68/18/11/3 | 11,000 | 1.31 |
| A-15 | 65/12/6/17 | 10500 | 1.43 |
| A-16 | 60/15/8/17 | 9800 | 1.51 |
| A-17 | 67/10/5/18 | 8900 | 1.44 |

The acid generators used in the examples of the invention are synthesized according to known methods, e.g., the synthesis method disclosed in JP-A-2002-27806.

### Example 1

### (1) Preparation and Coating of Resist

| | |
|---|---|
| Resin A-1 | 0.93 g |
| Sulfonic acid generator B-2 | 0.065 g |

These components are dissolved in 8.8 g of propylene glycol monomethyl ether acetate, further 0.003 g of D-1 (shown below) as the organic basic compound, and 0.001 g of Megafac F176 (manufactured by Dainippon Ink and Chemicals Inc., hereinafter abbreviated to W-1) as the surfactant are added and dissolved. The obtained solution is filtered through a membrane filter having a pore size of 0.1 μm to obtain a resist solution.

The obtained resist solution is coated on a 6-inch silicon wafer with a spin coater Mark 8 (manufactured by Tokyo Electron Limited), baked at 110° C. for 90 seconds to obtain a uniform film having a thickness of 0.25 μm.

### (2) Manufacture of Positive Pattern

The resist film is subjected to electron beam irradiation with an electron beam imaging apparatus (HL750, accelerating voltage: 50 KeV, manufactured by Hitachi Limited). After irradiation, the resist film is baked at 110° C. for 90 seconds, immersed in a 2.38 mass % tetramethylammonium hydroxide (TMAH) aqueous solution for 60 seconds, rinsed with water for 30 seconds, and dried. The obtained pattern is evaluated according to the following method.

(2-1) Sensitivity:

The cross sectional form of the obtained pattern is observed with a scanning electron microscope (S-4300, manufactured by Hitachi Limited). The minimum irradiation energy required for resolving 0.15 μm line (line/space is 1/1) is taken as sensitivity.

(2-2) LWR (Line Width Roughness)

The resist pattern obtained in the same manner as above is observed for the line width with a scanning electron microscope (S-9200, manufactured by Hitachi Limited), and fluctuation in line width in line width of 130 nm (LWR) is observed. By using a scanning electron microscope (SEM), the line width is detected at a plurality of positions in the measuring monitor, and three times the variance (σ) of the detected positions is taken as the index of LWR.

(2-3) Iso Dense Bias:

In a 0.15 μm line pattern in irradiation dose showing the above sensitivity, the line width of a dense pattern (line/space is 1/1) and the line width of a lone pattern are measured, and the difference between both values is taken as Iso Dense Bias.

The results in Example 1 are shown in Table 2 below.

### Examples 2 to 7 and Comparative Example 1

With the compounds shown in Table 2, each resist solution is manufactured, coated, and irradiated with electron beam in the same manner as in Example 1. The results of evaluation are shown in Table 2 below.

The components (C) and other components used in the examples and the resin used in comparative examples are shown below.

Organic Basic Compounds:

D-1: Tri-n-hexylamine

D-2: 2,4,6-Triphenylimidazole

D-3: Tetra-(n-butyl)ammonium hydroxide

Other Components (Surfactants):

W-1: Megafac F176 (fluorine surfactant, manufactured by Dainippon Ink and Chemicals Inc.)

W-2: Megafac R08 (fluorine/silicon surfactant, manufactured by Dainippon Ink and Chemicals Inc.)

W-3: Siloxane polymer KP-341 (silicon surfactant, manufactured by Shin-Etsu Chemical Co., Ltd.)

TABLE 2

| | | | Carboxylic | | | | | Density |
|---|---|---|---|---|---|---|---|---|
| | | Sulfonic Acid | Acid | Base | Other | Sensitivity | LWR | Dependency |
| Example No. | Resin | Generator | Generator | (0.003 g) | Component | (μC/cm²) | (nm) | (nm) |
| Example 1 | A-1 | B-2 | — | D-1 | W-1 | 13.5 | 9.8 | 17 |
| | (0.93 g) | (0.07 g) | | | | | | |
| Example 2 | A-2 | B-4 | — | D-2 | W-1 | 12.5 | 9.6 | 14 |
| | (0.35 g) | (0.07 g) | | | | | | |
| Example 3 | A-3 | B-16 | — | D-3 | W-2 | 11.0 | 8.6 | 13 |
| | (0.35 g) | (0.07 g) | | | | | | |
| Example 4 | A-4 | B-17 | — | D-1 | W-2 | 10.5 | 8.5 | 12 |
| | (0.25 g) | (0.07 g) | | | | | | |
| Example 5 | A-13 | B-1 | — | D-3 | W-1 | 9.0 | 6.7 | 10 |
| | (0.35 g) | (0.07 g) | | | | | | |
| Example 6 | A-6 | B-3 | C-1 | D-3 | W-1 | 10.0 | 7.1 | 10 |
| | (0.35 g) | (0.03 g) | (0.04 g) | | | | | |
| Example 7 | A-14 | B-5 | C-3 | D-2 | W-1 | 8.5 | 6.3 | 9 |
| | (0.35 g) | (0.03 g) | (0.04 g) | | | | | |
| Comparative | A′-1 | B-2 | — | D-1 | W-1 | 15.0 | 12.1 | 25 |
| Example 1 | (0.93 g) | (0.07 g) | | | | | | |

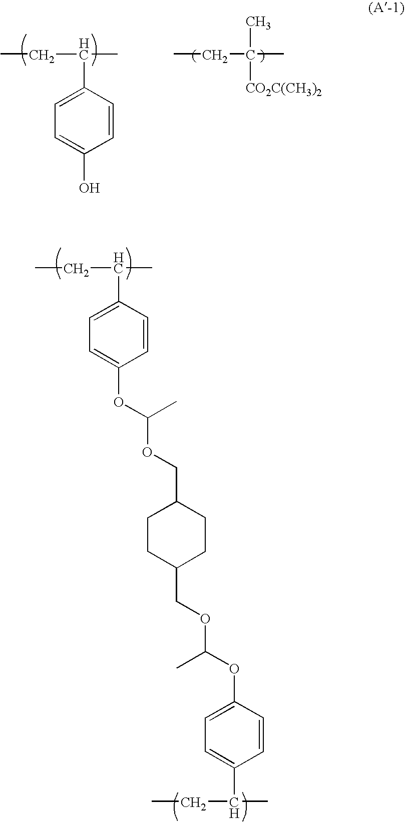 Molar ratio of compositions: 65/20/15, weight average molecular weight: 9,500, the polydispersity: 1.88

From the results shown in Table 2, concerning the pattern formation by irradiation with electron beam, it can be seen that the resist composition of the invention is high in sensitivity and low in LWR and Iso Dense Bias, so that excellent as compared with the case of using the compound of Comparative Example 1.

### Example 8

The resist solution shown in Table 3 is prepared in the same manner as in Example 1 except for changing the amount of sulfonic acid generator B-2 to 0.030 g, and a resist film is obtained by coating the resist solution. The film thickness is made 0.40 μm.

### (3) Manufacture of Positive Pattern

The obtained resist film is subjected to pattern exposure with a KrF excimer laser stepper (FPA3000EX-5, wavelength: 248 nm, manufactured by Canon Inc.). The processes after exposure are the same as in Example 1. Each pattern is evaluated as follows.

(3-1) Sensitivity:

The cross sectional form of the obtained pattern is observed with a scanning electron microscope (S-4300, manufactured by Hitachi Limited). The minimum irradiation energy required for resolving 0.18 μm line (line/space is 1/1) is taken as sensitivity.

(3-2) LWR (Line Width Roughness):

The resist pattern obtained in the same manner as above is observed for the line width with a scanning electron microscope (S-9220, manufactured by Hitachi Limited), and fluctuation in line width in line width of 130 nm (LWR) is observed. By using a scanning electron microscope (SEM), the line width is detected at a plurality of positions in the measuring monitor, and three times the variance (a) of the detected positions is taken as the index of LWR.

(3-3) Iso Dense Bias:

In a 0.18 μm line pattern in irradiation dose showing the above sensitivity, the line width of a dense pattern (line/space is 1/1) and the line width of a lone pattern are measured, and the difference between both values is taken as Iso Dense Bias. The results of evaluations are shown in Table 3 below.

### Examples 9 to 16 and Comparative Example 2

With the compounds shown in Table 3, each resist solution is manufactured, coated, and irradiated with KrF excimer laser in the same manner as in Example 8. The results of evaluation are shown in Table 3 below.

TABLE 3

| | | | Carboxylic | | | | | Density |
|---|---|---|---|---|---|---|---|---|
| | | Sulfonic Acid | Acid | Base | Other | Sensitivity | LWR | Dependency |
| Example No. | Resin | Generator | Generator | (0.003 g) | Component | (mJ/cm²) | (nm) | (nm) |
| Example 8 | A-1 (0.93 g) | B-2 (0.03 g) | — | D-1 | W-1 | 18.3 | 9.5 | 20 |
| Example 9 | A-3 (0.35 g) | B-4 (0.03 g) | — | D-2 | W-1 | 15.2 | 9.6 | 19 |
| Example 10 | A-5 (0.35 g) | B-16 (0.03 g) | — | D-3 | W-2 | 14.3 | 9.1 | 23 |
| Example 11 | A-7 (0.25 g) | B-17 (0.03 g) | — | D-1 | W-2 | 13.8 | 8.5 | 18 |
| Example 12 | A-13 (0.35 g) | B-1 (0.03 g) | — | D-3 | W-1 | 12.5 | 7.6 | 14 |
| Example 13 | A-11 (0.35 g) | B-3 (0.01 g) | C-2 (0.02 g) | D-3 | W-1 | 15.0 | 8.5 | 17 |
| Example 14 | A-14 (0.35 g) | B-5 (0.01 g) | C-4(0.02 g) | D-2 | W-1 | 12.9 | 6.8 | 13 |
| Example 15 | A-16 (0.35 g) | B-1 (0.03 g) | | D-1 | W-1 | 13.2 | 8.1 | 18 |
| Example 16 | A-17 (0.35 g) | B-2 (0.023 g) | | D-1 | W-1 | 13.6 | 7.9 | 20 |
| Comparative | A′-1 (0.93 g) | B-2 (0.03 g) | — | D-1 | W-1 | 35.2 | 13.2 | 36 |
| Example 2 | | | | | | | | |

From the results shown in Table 3, concerning the pattern formation by irradiation with KrF excimer laser, it can be seen that the resist composition of the invention is high in sensitivity and low in LWR and Iso Dense Bias, so that excellent as compared with the case of using the compound of Comparative Example 2.

### Examples 17 to 23 and Comparative Example 3

With the resist composition shown in Table 4, each resist film is manufactured in the same manner as in Example 1. However, the film thickness of the resist is made 0.13 μm. The obtained resist film is subjected to areal exposure with EUV ray (having a wavelength of 13 nm) by varying the exposure dose 0.5 by 0.5 mJ within the range of exposure dose of from 0 to 5.0 mJ, and further to baking at 110° C. for 90 seconds. After that, a dissolution rate of the resist film at each exposure dose is measured with a 2.38 mass % tetramethylammonium hydroxide (TMAH) aqueous solution to obtain a sensitivity curve. In the sensitivity curve, the exposure dose at the time when the dissolution rate of the resist is saturated is taken as sensitivity, and dissolution contrast (γ value) is computed from the gradient of the straight line part of the sensitivity curve. The greater the γ value, the better is the dissolution contrast.

The results obtained are shown in Table 4 below.

TABLE 4

| | | | Carboxylic | | Other | | |
|---|---|---|---|---|---|---|---|
| | | Sulfonic Acid | Acid | Base | Component | Sensitivity | |
| Example No. | Resin | Generator | Generator | (0.003 g) | (0.001 g) | (mJ/cm²) | γ Value |
| Example 17 | A-1 | B-2 | — | D-1 | W-1 | 10.5 | 7.9 |
| | (0.93 g) | (0.05 g) | | | | | |
| Example 18 | A-2 | B-4 | — | D-2 | W-1 | 9.5 | 8.1 |
| | (0.35 g) | (0.03 g) | | | | | |
| Example 19 | A-3 | B-16 | — | D-3 | W-2 | 9.3 | 8.3 |
| | (0.35 g) | (0.03 g) | | | | | |
| Example 20 | A-4 | B-17 | — | D-1 | W-2 | 9.1 | 8.9 |
| | (0.25 g) | (0.03 g) | | | | | |
| Example 21 | A-13 | B-1 | — | D-3 | W-1 | 7.0 | 9.2 |
| | (0.35 g) | (0.03 g) | | | | | |
| Example 22 | A-6 | B-3 | C-5 | D-3 | W-3 | 8.9 | 9.1 |
| | (0.35 g) | (0.015 g) | (0.015 g) | | | | |
| Example 23 | A-14 | B-5 | C-9 | D-2 | W-3 | 7.3 | 9.8 |
| | (0.35 g) | (0.015 g) | (0.015 g) | | | | |
| Comparative | A′-1 | B-2 | — | D-1 | W-1 | 16.3 | 6.5 |
| Example 3 | (0.93 g) | (0.03 g) | | | | | |

From the results shown in Table 4, characteristic evaluation by irradiation with EUV ray, it can be seen that the resist composition of the invention is high in sensitivity and high in contrast, and excellent as compared with the case of using the composition of Comparative Example 3.

The invention can provide a resist composition that is high in sensitivity, good in LWR, reduced in Iso Dense Bias, and showing excellent dissolution contrast in connection with pattern formation by irradiation with electron beams, KrF excimer laser beams, or EUV rays; and a pattern forming method using the same.

The entire disclosure of each and every foreign patent application from which the benefit of foreign priority has been claimed in the present application is incorporated herein by reference, as if fully set forth.

What is claimed is:

1. A resist composition comprising:
(A) a resin that comprises:
a repeating unit represented by the following formula (1), and
an acid-decomposable crosslinking group; and
(B) a compound that generates an acid upon irradiation with an actinic ray or radiation: 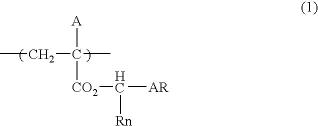
wherein AR represents a benzene ring or a naphthalene ring;
Rn represents an alkyl group, a cycloalkyl group, or an aryl group; and
A represents a hydrogen atom, an alkyl group, a cycloalkyl group, a halogen atom, a cyano group, or an alkyloxycarbonyl group.

2. The resist composition according to claim 1,
wherein the acid-decomposable crosslinking group is a group represented by the following formula (2) or (3): 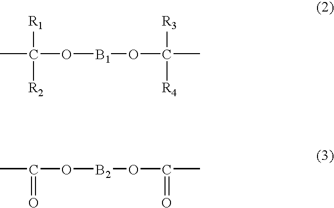
wherein R₁, R₂, R₃ and R₄ may be the same or different, each of them represents a hydrogen atom, an alkyl group, or a cycloalkyl group, R₁ and R₂ do not represent a hydrogen atom at the same time, R₃ and R₄, do not represent a hydrogen atom at the same time, R₁ and R₂ may form a ring, and R₃ and R₄, may form a ring;
B₁ represents a divalent organic group, and at least one of whose bonds with the adjacent oxygen atoms is broken by action of an acid; and
B₂ represents a divalent organic group and at least one of whose bonds with the adjacent oxygen atoms is broken by action of an acid.

3. The resist composition according to claim 1,
wherein the resin (A) further comprises a repeating unit represented by the following formula (4): 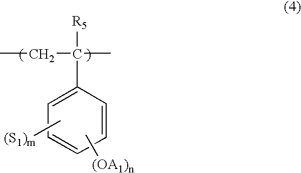
wherein n and m each represents an integer of from 0 to 3, provided that m+n≦5;
A₁ represents a hydrogen atom, or a group comprising a group that decomposes by action of an acid, and when two or more A₁s are present, they may be the same or different;
S₁ represents a substituent, and when two or more S₁s are present, they may be the same or different; and
R₅ represents a hydrogen atom, an alkyl group, a cycloalkyl group, a halogen atom, a cyano group, or an alkyloxycarbonyl group.

4. The resist composition according to claim 3,
wherein the group represented by A₁ comprises a cyclic carbon structure.

5. A pattern forming method comprising:
a processes of forming a resist film with the resist composition according to claim 1;
a process of exposing the resist film; and
a process of developing the resist film.

6. A resin comprising:
a repeating unit represented by the following formula (1); and
an acid-decomposable crosslinking group: 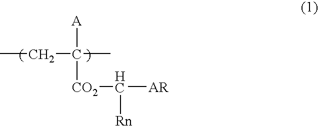
wherein AR represents a benzene ring or a naphthalene ring;
Rn represents an alkyl group, a cycloalkyl group, or an aryl group; and
A represents a hydrogen atom, an alkyl group, a cycloalkyl group, a halogen atom, a cyano group, or an alkyloxycarbonyl group.
